(19) United States
(12) Patent Application Publication
(10) Pub. No.: US 2008/0131812 A1
(43) Pub. Date: Jun. 5, 2008

(54) Resin for printing plate material and lithographic printing plate material by use thereof

(75) Inventor: Hidetoshi Ezure, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/985,940

(22) Filed: Nov. 19, 2007

(30) Foreign Application Priority Data
Nov. 30, 2006 (JP) JP2006-323331

(51) Int. Cl. G03C 1/46

(52) U.S. Cl. 430/270.1; 430/286.1

(57) ABSTRACT

Disclosed is a lithographic printing plate material comprising on a support a light-sensitive layer comprising a binder resin, wherein the light sensitive layer comprises a resin containing a group of a cyclic ureido residue derived from a cyclic ureido compound represented by formulas (1), (2), (3), (4) or (5):

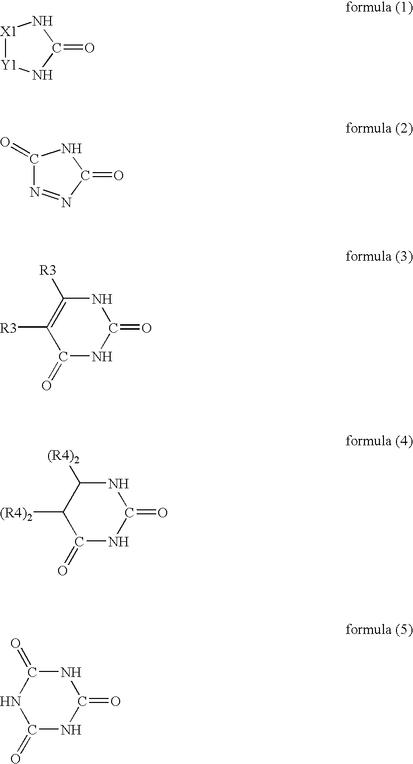

This application claims priority from Japanese Patent Application No. JP2006-323331 filed on Nov. 30, 2006, which is incorporated hereinto by reference.

### FIELD OF THE INVENTION

The present invention relates to a resin material for use in a positive-working light-sensitive lithographic printing plate, a so-called computer-to-plate (or CTP) system and a lithographic printing plate having a light-sensitive layer using the resin material, and in particular to a lithographic printing plate material which is capable of forming an image upon exposure to a near-infrared laser and is superior in sensitivity, development latitude, abrasion resistance and chemical resistance.

### BACKGROUND OF THE INVENTION

Recently, a CTP system in which digital data are directly modulated into laser signals and a lithographic printing plate material is exposed thereto, has become widely used along with digitization of printing data. Recent developments of lasers have been remarkable specifically in solid laser/semiconductor lasers exhibiting emission in the region of near-infrared to infrared and high-power and compact ones are readily available. These lasers are very effective as a light source for exposure to make a printing plate from digital data processed by a computer or the like.

Also recently, enhanced productivity of an exposure device, that is, shortening of exposure time and conveyance time has been achieved along with quicker delivery of prints. There has been also achieved enhanced productivity in printing, such as two-plate setting or four plate setting of large-size printing plates. In the foregoing situation, abrasion on the plate material, due to conveyance occasionally occurred in a exposure machine corresponding to large-size plates and an improvement of the exposure device was pursued but was not enough achieved, so that the improvement of a printing plate material is still desired.

Further, a positive-working printing plate material having a recording layer containing (A) an alkali-soluble resin having a phenolic hydroxyl group, such as cresol novolac resin and (B) an infrared absorber is known as an infrared laser lithographic printing plate material, as described in, for example, International Publication No. 97/39894. In this positive-working printing plate material, an exposed area causes a change in the association state of the cresol novolac resin by heat generated from the infrared absorber upon exposure, resulting in a difference in solubility (or solubility difference) from an unexposed area and development is performed by employing such solubility difference to form images. However, such solubility difference was so small that the development latitude was narrow or the heat content of a portion near the support was reduced, producing problems such that an effect of disappearance of development inhibiting capability (clear sensitivity) was not sufficiently achieved.

To overcome such problems as insufficient sensitivity or narrow development latitude, there were proposed lithographic printing plate materials in which an amido group was introduced to a novolac resin through an esterification reaction to change the association state of the novolac resin or to enhance hydrogen bonding, or a quinone diazide group was introduced through esterification of a sulfonic acid to enhance sensitivity or development latitude, as set forth in, for example, published Japanese translation of PCT international publication for patent application No. 2002-210404 and JP-A No. 11-288089 (hereinafter, the term JP-A refers to Japanese Patent Application Publication). However, introduction of substituent groups, as described above, improved sensitivity or development latitude only to a certain extent but its effectiveness was still insufficient in its effectiveness, and was also insufficient in abrasion resistance in a high-speed exposure for a large-size printing plate material.

There was also proposed a novolac resin containing a substituent containing a bonding site having a non-covalent electron pair capable of forming a hydrogen bond, as set forth in, for example, published Japanese translation of PCT international publication for patent application No. 2004-526986. The foregoing hydrogen bond is formed by identical paired substituents and interaction between at least two hydrogen bonds resulted in enhancement of development latitude and also of chemical resistance, however, such results were still insufficient for a developer exhibiting a pH of 13.0 or less or an exhausted developer, and abrasion resistance in high-speed exposure machines for large-size plate materials was also insufficient.

### SUMMARY OF THE INVENTION

The present invention has come into being in view of the foregoing problems. It is therefore an object of the invention to provide a lithographic printing plate material exhibiting abrasion resistance required of high productivity in large-size plates and enhanced sensitivity and superior development latitude even when used with low pH or exhausted developer, and a resin material used in the lithographic printing material.

The foregoing problem was overcome by the following constitution:

One aspect of the invention is directed to a lithographic printing plate material comprising on a support a light-sensitive layer comprising a binder, wherein the light sensitive layer comprises a resin having a cyclic ureido residue as a group that is derived from a cyclic ureido compound represented by formulas (1), (2), (3), (4) or (5):

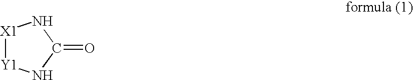

wherein X1 and Y1 are each independently —O—, —N(R1)- or —C(R1)₂- in which R1 is a hydrogen atom, a halogen atom or a substituent, or X1 and Y1 are —C(═O)—;

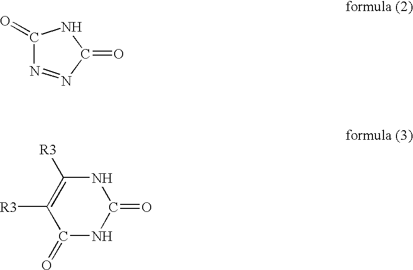

wherein R3 is the same as defined in R1;

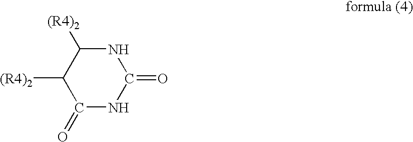

wherein R4 is the same as defined in R1;

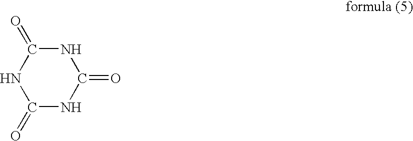

### DETAILED DESCRIPTION OF THE INVENTION

According to the invention described above, there can be provided a lithographic printing plate material exhibiting abrasion resistance which is required for high productivity in large-size plates and enhanced sensitivity and superior development latitude even when used with low pH or exhausted developer, and a resin material used in the printing plate material.

In the lithographic printing plate of the invention, the light-sensitive layer comprises a resin having a cyclic ureido residue derived from a cyclic ureido compound represented by the foregoing formulas (1)-(5). Herein, the cyclic ureido residue derived from a cyclic ureido compound refers to a cyclic ureido residue (or moiety) obtained by replacing at least one atom constituting the ureido compound with a bond. Thus, the light-sensitive layer contains a resin with an attached cyclic ureido residue selected from the cyclic ureido compounds of the foregoing formulas (1)-(5).

The working mechanism of the invention is not clear but it is assumed to be as follows.

The resin of the invention, which contains a cyclic ureido residue (or ureido moiety) derived from a cyclic ureido compound as a group, has a ureido bond, specifically two or more amide bonds so that interaction between resins or between the resin and an additive which is mainly due to hydrogen bond becomes stronger, resulting in image areas of enhanced mechanical strength or reduced solubility in a developer or chemicals and thereby achieving enhancement of abrasion resistance, chemical resistance and plate life. In particular, it is assumed that, since the foregoing ureido bond, specifically two or more amide bonds exist in the ring structure, two cyclic ureido residues can simultaneously form hydrogen bonds with the said ureido residue (or residue), realizing stronger interaction than a single hydrogen bond (as shown below in chemical structure 1). Further, it is assumed that the foregoing strong interaction is loosened upon exposure (heating), whereby favorable sensitivity or development latitude can be maintained even in a low-active developer such as a low pH or exhausted developer.

A combination of the resin containing the foregoing ureido residues with a specific acid-decomposable compound, an acid generating agent or a resin binder strengthens the interaction between the resins and/or between the resin and a compound, resulting in further enhanced effects of the invention. This is markedly effectuated in two functional-separated light-sensitive layers and it is therefore contemplated that a superior printing plate can be obtained by appropriate incorporation or compounding of the resin of the invention.

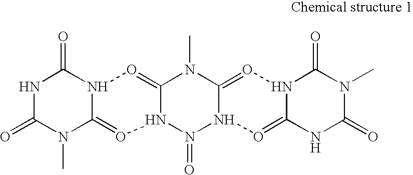

There will be further detailed the lithographic printing plate of the invention and constituting elements thereof.

The resin of the invention, used for a printing plate material is a resin which contains a cyclic ureido residue derived from a cyclic ureido compound selected from cyclic ureido compounds represented by formulas (1)-(5):

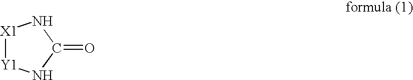

wherein X1 and Y1 are each independently —O—, —N(R1)- or —C(R1)₂-, or X1 and Y1 are —C(═O)— in which R1 is a hydrogen atom, a halogen atom or a substituent such as an alkyl group, a cycloalkyl group, a halogenated alkyl group, an alkenyl group, an alkynyl group, an aryl group, a heterocyclic group, a halogen atom, a cyano group, a hydroxy group, a carboxyl group, an alkoxy group, an aryloxy group, a silyloxy group, a heterocycli-oxy group, an acyloxy group, a carbamoyloxy group, an alkoxycarbonyloxy group, an aryloxycarbonyloxy group, an amino group, an anilino group, an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic-thio group, a sulfamoyl group, a sulfo group, an alkyl- or aryl-sulfinyl group, an alkyl-aryl-sulfonyl group, an acyl group, an aryloxycarbonyl group, an alkoxycarbonyl group, a carbamoyl group, an aryl- or heterocyclic-azo group, an imido group, a silyl group, a hydrazine group, a ureido group, a boronic acid group, a phosphate group and a sulfato group;

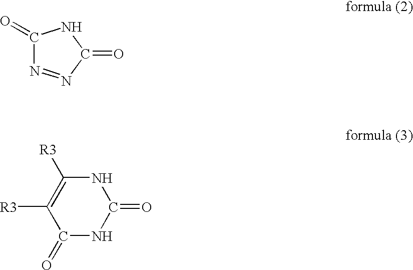

wherein R3 is the same as defined in R1;

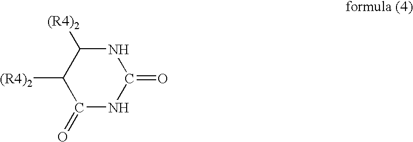

wherein R4 is the same as defined in R1;

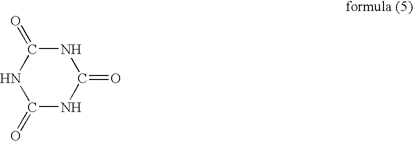

Of cyclic ureido compounds selected from the compounds represented by formulas (1) to (5) is preferred a cyclic ureido compound having at least two amide bonds. Such a cyclic ureido structure having at least two amide bonds forms a hydrogen bond between the ureido residues derived from the ureido compound and one ureido residue can form hydrogen bonds concurrently with two other ureido residues, resulting in strong interaction. According to the foregoing, a supramolecule may also be formed. The supramolecule refers to a compound in which plural molecules are held together or organized by means of intermolecular (noncovalent) binding interactions, i.e., via coordination bond or hydrogen bond.

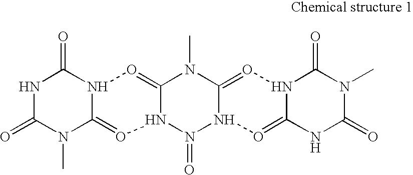

Specific examples of a cyclic ureido compound selected from cyclic ureido compounds represented by the aforementioned formulas (1)-(5) include imidazolidinone, urazole, triazolinedione, parabanic acid, uracil, thymine, orotic acid, isocyanuric acid and their derivatives. Of these, urazole, parabanic acid, uracil, thymine, orotic acid, isocyanuric acid, each of which has two amide bonds and their derivatives are preferred. Six-membered ring uracil, thymine, isocyanuric acid and their derivatives are more preferred in terms of hydrogen bond formation (in which one substituent forms hydrogen bonds with two substituents), and isocyanuric acid having most amide bonds and its derivatives are still more preferred.

Derivatives of cyclic ureido compounds of the invention are not specifically limited in structure and specific examples are described with reference to isocyanuric acid.

As isocyanuric acid derivatives are cited those represented by the formula as below:

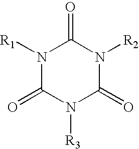

wherein R₁, R₂ and R₃ are each a hydrogen atom, a hydroxy group, a carboxyl group, an amino group, a cyano group, —R₄-(A)ₙ, —R′₄-(A′)_{n′}-(reactive group) or a polymerizable group.

In the formula, A and A′ are each a linking group, and n and n′ are each 0 or 1. The linking group A and A′, each represents a polar group such as a carboxylic acid ester group, a urea group, a urethane group, an amido group, an imido group, a sulfonamido group, sulfonyl group, a sulfonic acid ester group; R₄ represents an alkyl group, an allyl group, an alkenyl group, an aryl group or an alkyleneoxide group, each of which has 1 to 10 carbon atoms.

Examples of the reactive group include an isocyanate group, an epoxy group, an active methylene group, an amino group, a thiol group, a hydroxy group, a mercapto group, an oxetane group, a carbodiimide group, an oxazine group and a metal alkoxide.

The polymerizing group is represented as below:

—(B)ₙ—C

wherein C is an ethylenically unsaturated group, which is —CH═CH₂, —C(CH₃)═CH₂, —O—CH═CH₂, —OC(CH₃)═CH₂, —O-c(=O)CH═CH₂ or —O—C(═O)C(CH₃)═CH₂.

B is a linking group, and n is 1 or 0. The linking group B (or —B—) is also represented by R₃-D [or —R₅(D)-]. R₅ is an alkyl group, an allyl group, an alkenyl group, an aryl group or an alkyleneoxide group, each of which has 1 to 5 carbon atoms. R₅ may be branched and the branched portion may be bonded to a hydroxy group or a carboxy group. D is a polar group, including a carboxylic acid ester group, an amido group, a cyano group, a sulfonamido group, an imido group, a sulfonyl group and a sulfonic acid ester group.

The resin used in the printing plate material of invention, which is soluble in an aqueous alkaline solution, is used as a binder of the printing plate material. The resin may comprise a backbone having a side chain, and the side chain may contain the foregoing cyclic ureido residue derived from the cyclic ureido compound or the backbone of the resin may have a substituent of the cyclic ureido residue. Preferably, the side chain has a substituent of the cyclic ureido residue derived from the ureido compound in terms of interactions between resins and/or additives being readily performed.

Examples of a resin soluble in aqueous alkali include a resin containing a phenolic hydroxy group (hereinafter, also denoted as a phenol resin), a vinyl resin (e.g., acryl resin, acetal resin), a urethane resin. A polyester resin and an amide resin. There will be described resins usable in the invention.

### Aqueous Alkali-Soluble Resin:

A resin soluble in aqueous alkali (which is also denoted as aqueous alkali-soluble resin or simply as alkali-soluble resin) refers to one which is soluble in an aqueous potassium hydroxide solution of a pH of 13, in an amount of not less than 1 g/l. A resin containing a phenolic hydroxy group, acryl resin and acetal resin as a alkali-soluble resin are preferred in terms of ink receptivity and alkali solubility.

An alkali-soluble resin may be composed of a single constituent or two or more constituents in combination. An alkali-soluble resin used for the lower layer is preferably mainly composed of an acryl resin or an acetal resin in terms of solubility in aqueous alkali solution and an alkali-soluble resin used for the upper layer is preferably composed of a resin containing a phenolic hydroxy group in terms of ink receptivity.

### Phenol Resin:

Phenol resins (or resins containing a phenolic hydroxy group) include a novolac resin which is formed of condensation of phenols with aldehydes.

Phenols include, for example, phenol, m-cresol. P-cresol, a mixture of m- and p-cresols, a mixture of phenol and cresol (m- or p-cresol or mixture-thereof), pyrogallol, an acrylamide containing a phenolic hydroxy group, methacrylamide, an acrylic acid ester, a methacrylic acid ester and hydroxystyrene.

As substituted phenols are cited isopropylphenol, t-butylphenol, t-amylphenol, hexylphenol, cyclohexylphenol, 3-methyl-4-chloro-6-t-butylphenol, isopropylcresol, t-butylcresol, and t-amylcresol. Of these are preferred t-butylphenol and t-butylcresol. Examples of aldehydes include aliphatic aldehydes such as formaldehyde, acetaldehyde, acrolein and crotonaldehyde, and aromatic aldehydes. Of these are preferred formaldehyde and acetaldehyde, and formaldehyde is more preferred.

Of the foregoing combinations are preferred phenol-formaldehyde, m-cresol-formaldehyde, p-cresol-formaldehyde, m- and p-cresols-formaldehyde, mixed phenol/cresol (m-, p-, mixed m-/p-, mixed m-/o- or mixed o-/p-cresol)-formaldehyde.

A novolac resin having a weight average molecular weight of not less than 1,000 and a number average molecular weight of not less than 200 is preferred, one having a weight average molecular weight of 1,500-300,000, a number average molecular weight of 300-250,000 and a dispersion degree (which is a ratio of weight average molecular weight to number average molecular weight) of 1.1 to 10 is more preferred and one having a weight average molecular weight of 2,000-10,000, a number average molecular weight of 500-10,000 and a dispersion degree of 1.1 to 5 is specifically preferred. A novolac resin falling within the foregoing range can appropriately control layer strength, alkali solubility, solubility in chemicals and interaction with a photothermal conversion material, rendering it easy to achieve the targeted effects of the invention. The weight average molecular weight of a novolac resin used in the upper or lower layer can be controlled. The weight average molecular weight of a novolac resin used in the upper layer which requires resistance to chemicals and layer strength is preferably from 2,000 to 10,000.

In the invention, the weight average molecular weight of a novolac resin employs equivalent converted to polystyrene which was determined by gel permeation chromatography (GPC) employing a monodisperse polystyrene as reference.

A novolac resin can be manufactured by a method, for example, as described in “Shin-Jikken Kagaku Koza [19] Kobunshikgaku [I]” (193, Maruzen Shuppan) page 300, in which phenol and a substituted phenol (e.g., xylenol, cresols) are reacted with aqueous form aldehyde by using a catalyst in a solvent to perform dehydration condensation of phenol, the o- or p-position of the substituted phenol and formaldehyde. The thus obtained novolac resin is dissolved in an organic polar solvent and after adding an optimal amount of a non-polar solvent and allowing it to stand for a few hours, the novolac solution is separated into two layers. The separated lower layer solution is condensed, whereby a novolac resin having an intensive molecular weight is prepared.

Examples of an organic polar solvent include acetone, methyl alcohol and ethyl alcohol. Examples of a nonpolar solvent include hexane and petroleum ether. The manufacturing method is not limited to the foregoing method but, for example, as described in published Japanese translation of PCT international publication No. 2001-506294, for example, a novolac resin is dissolved in a water-soluble organic polar solvent and water is added thereto to form precipitates to obtain a novolac resin fraction. To obtain a novolac resin exhibiting a lower dispersion degree, it is feasible to dissolve a novolac resin obtained by dehydration condensation of phenol derivatives in an organic solvent, followed by molecular weight fractionation using a silica gel.

The dehydration condensation reaction of phenol and the o- or p-position of phenol and substituted phenol components with formaldehyde is performed in such a manner that the phenol and substituted phenol components are added to a solvent at a total concentration of 60 to 90% by mass (preferably 70 to 80% by mass.) and further thereto, formaldehyde is added at a molar ratio of formaldehyde to the phenol and substituted phenol components of 0.2 to 2.0 (preferably 0.4 to 1.4 and more preferably 0.6 to 1.2), and an acid catalyst is further added at a molar ratio of the catalyst to the phenol and substituted phenol components of 0.01 to 0.1 (preferably 0.02 to 0.05) under the temperature condition of 10 to 150° C. and stirred for a few hours, while maintaining the temperature range. The reaction temperature is preferably from 70 to 150° C., and more preferably from 90 to 140° C.

Novolac resins may be used singly or in combination. The combined use of two or more resins can effectively employ different characteristics such as layer strength, solubility in chemicals and interaction with the photothermal conversion material. When two or more novolac resins are used in combination in the image forming layer, a combination which differs in weight average molecular weight or an m/p ratio being as large as possible, is preferred. For instance, a difference in weight average molecular weight is preferably not less than 1,000, and more preferably not less than 2,000; while the difference in m/p is preferably not less than 0.2, and more preferably not less than 0.3.

In the lithographic printing plate material, a resin containing a phenolic hydroxy group is added preferably in an amount of 30 to 99% by mass, based on solids of the upper layer in terms of chemical resistance and plate life, more preferably from 45 to 95% by mass, and still more preferably from 60 to 90% by mass.

### Acryl Resin

Copolymers having constituting units described below are preferably used as a acryl resin. Suitably used constituting units include, for example, ones derived from commonly known monomers, such as acrylic acid esters, methacrylic acid esters, acrylamides, methacrylamides, vinyl esters, styrenes, acrylic acid, methacrylic acid, maleic acid anhydride, maleic acid imide and lactones.

Specific examples of acrylic acid esters include methyl acrylate, ethyl acrylate, (n- or i-)propyl acrylate, (n-, i-, sec- or t-)butyl acrylate, amyl acrylate, 2-ethylhexyl acrylate, dodecyl acrylate, chloromethyl acrylate, 2-hydroxyethyl acrylate, 2-hydroxypropyl acrylate, 5-hydroxypentyl acrylate cyclohexyl acrylate, allyl acrylate, trimethylolpropane monoacrylate, pentaerythritol monoacrylate, glycidyl acrylate, benzyl acrylate, methoxybenzyl acrylate, chlorobenzyl acrylate, 2-(p-hydroxyphenyl)ethyl acrylate, furfuryl acrylate, tetrahydrofurfuryl acrylate, phenyl acrylate, chlorophenyl acrylate, and sulfamoyl acrylate.

Specific examples of methacrylic acid esters include methyl methacrylate, ethyl methacrylate, (n- or I-)propyl methacrylate, (n-, i-, sec- or t-)butyl methacrylate, amyl methacrylate, 2-ethylhexyl methacrylate, dodecyl methacrylate, chloroethyl methacrylate, 2-hydroxyethyl methacrylate, 2-hydroxypropyl methacrylate, 2-hydroxypentyl methacrylate, cyclohexyl methacrylate, allyl methacrylate, trimethylolpropane monomethacrylate, pentaerythritol monomethacrylate, glycidyl methacrylate, methoxybenzyl methacrylate, chlorobenzyl methacrylate, 2-(p-hydroxyphenyl)ethyl methacrylate, furfuryl methacrylate, tetrahydrofurfuryl methacrylate, phenyl methacrylate, chlorophenyl methacrylate, and sulfamoyl methacrylate.

Specific examples of acrylamides include acrylamide, N-methyl acrylamide, N-ethyl acrylamide, N-butyl acrylamide, N-benzyl acrylamide, N-hydroxyphenyl acrylamide, N-phenyl acrylamide, N-tolyl acrylamide, N-(p-hydroxyphenyl)acrylamide, N-(sulfamoylphenyl)acrylamide, N-(phenylsulfonyl)acrylamide, N-(tolylsulfonyl)acrylamide, N,N-dimethyl acrylamide, N-methyl-N-phenyl acrylamide, N-hydroxyethyl-N-methyl acrylamide, and N-(p-toluenesulfonyl) acrylamide.

Specific examples of methacrylamides include methacrylamide, N-methyl methacrylamide, N-ethyl methacrylamide, N-butyl methacrylamide, N-benzyl methacrylamide, N-hydroxyphenyl methacrylamide, N-phenyl methacrylamide, N-tolyl methacrylamide, N-(p-hydroxyphenyl)methacrylamide, N-(sulfamoylphenyl)methacrylamide, N-(phenylsulfonyl)methacrylamide, N-(tolylsulfonyl)methacrylamide, N,N-dimethyl methacrylamide, N-methyl-N-phenyl methacrylamide, N-hydroxyethyl-N-methyl methacrylamide, and N-(p-toluenesulfonyl)methacrylamide.

Specific examples f lactones include pantoyllactone(meth)acrylate, α-(meth)acryloyl-γ-butylolactone, and β-(meth)acryloyl-γ-butylolactone.

Specific examples of maleic acid imides include maleimide, N-acryloyl acrylamide, N-acetyl methacrylamide, N-propionyl methacrylamide, and N-(p-chlorobenzoyl)methacrylamide. Specific examples of vinyl esters include vinyl acetate, vinyl butylate, and vinyl benzoate.

Specific examples of styrenes include styrene, methylstyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorostyrene, dichlorostyrene, bromostyrene, iodostyrene, fluorostyrene, and carboxystyrene.

Specific examples of acrylonitriles include acrylonitrile and methacrylonitrile.

Of these monomers are suitably used acrylic acid esters, methacrylic acid esters, acrylamides, methacrylamides, acrylic acid, methacrylic acid, acrylonitrile, and maleic acid imides, each of which has 20 or less carbons.

A copolymer which is constituted of monomers described above preferably has a weight average molecular weight (Mw) of not less than 2,000, more preferably from 5,000 to 100,000 and still more preferably from 10,000 to 50,000. A weight average molecular weight falling within the range described above can control layer strength, solubility in alkali and solubility in chemicals and renders it easy to achieve effects of the invention.

The polymerization form of an acryl resin may be any one of a random copolymer, a block copolymer and a graft copolymer, but a block copolymer in which a hydrophilic group and a hydrophobic group are phase-separable is preferred in terms of solubility in a developer being controllable.

Acryl resins may be used singly or in combination.

### Acetal Resin

An acetal resin can be synthesized in the manner that a polyvinyl alcohol is reacted with an aldehyde to form acetal and the residual hydroxy group is reacted with an acid anhydride.

Examples of such an aldehyde include formaldehyde, acetaldehyde, propylaldehyde, butylaldehyde, pentylaldehyde, hexylaldehyde, pentylaldehyde, hexylaldehyde, glyoxylaldehyde, N,N-dimethylformalamido-di-n-butylacetal, bromoacetoaldehyde, chloroacetoaldehyde, 3-hydroxy-n-butylaldehyde, 3-methoxy-n-butylaldehyde, 3-(dimethylamino)-2,2-dimethylpropionic aldehyde, and cyanoacetoaldehyde.

As an acetal resin is preferred a polyvinyl acetal resin represented by the following formula (PVAC): formula (PVAC)

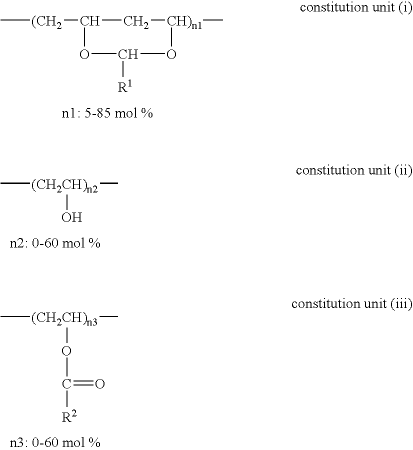

The polyvinyl acetal resin represented by the foregoing formula (PVAC) is formed of constitution unit (i) of a vinyl acetal constituent, constitution unit (ii) of a vinyl alcohol constituent and constituent unit (iii) of an unsubstituted ester constituent, and including at least one of the respective constituent units; n1, n2 and n3 represent constitution ratio (mol %) of the respective constitution units.

In the constitution unit (i), R₁ represents a hydrogen atom, an alkyl group, an aryl group, a carboxyl group or a dimethylamino group, each of which may be substituted by a substituent.

As such a substituent is cited a carboxyl group, a hydroxyl group, a chloro group, a bromo group, a urethane group, an ureido group, a tertiary amino group, an alkoxy group, a cyano group, a nitro group, an amido group, and an ester group. Specific examples of R₁ include a hydrogen atom, a methyl group, an ethyl group, a propyl group, a butyl group, a pentyl group, a carboxy group, a halogen atom (e.g., —Br, —Cl) a cyano-substituted methyl group, 3-hydroxybutyl group, 3-methoxybutyl group and a phenyl group. Of these, a hydrogen atom, a propyl group and a phenyl group are specifically preferred. Further, n1 is preferably from 5 to 85 mol % in terms of layer strength, plate life and solubility in a coating solvent, and more preferably from 25 to 70 mol %.

In the constitution unit (ii), n2 is preferably from 0 to 60 mol % and more preferably from 10 to 45 mol %. The constitution unit )ii) is superior in affinity to water, and when n2 is in the range of 0 to 60 mol, swelling capability in water is appropriately maintained and superior plate life is also held.

In the constitution unit (iii), R₂ represents an unsubstituted methyl group, a carboxy-containing aliphatic hydrocarbon group, alicyclic hydrocarbon group or aromatic hydrocarbon group and these hydrocarbon groups each have 1 to 20 carbon atoms. Specifically, an alkyl group having 1 to 10 carbon atoms is preferred, and a methyl group or an ethyl group is more preferred in terms of developability. Further, n3 is preferably in the range of 0 to 20 mol % in terms of plate life, and more preferably in the range of 1 to 10 mol %.

The acid content of a polyvinyl acetal resin is preferably from 0.5 to 5.0 meq/g (corresponding to 84 to 280 in term of mg number of KOH) and more preferably from 1.0 to 3.0 meq/g.

The weight average molecular weight of a polyvinyl acetal which is determined in gel permeation chromatography is preferably from 5,000 to 400,000 and more preferably from 20,000 to 300,000. A molecular weight falling with the foregoing range can control layer strength, solubility in alkali and solubility in chemicals, making it easy to achieve effects of the invention.

Polyvinyl acetal resins may be used singly or in combination.

Acetalization of polyvinyl alcohol is performed according to known methods, for example, described in U.S. Pat. No. 4,665,124, U.S. Pat. No. 4,940,646, U.S. Pat. No. 5,169,898, U.S. Pat. No. 5,700,619 and U.S. Pat. No. 5,792,823; Japanese Patent 09328519.

### Acryl Resin Containing Fluoroalkyl Group

An acryl resin containing fluoroalkyl group (hereinafter, also denoted as fluoroalkyl-containing acryl resin is a resin which contains a fluoroalkyl group and an acrylic acid derivative as a constitution unit.

A fluoroalkyl-containing acryl resin is preferably one which is obtained by polymerization of a compound represented by the following formula (FAC), of which its copolymer is specifically preferred:

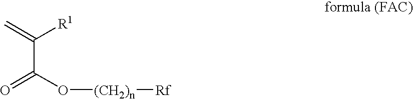

wherein Rf is a substituent containing a fluoroalkyl group having at least 3 fluorine atoms or a perfluoroalkyl group, n is 1 or 2, and R¹ is a hydrogen atom or an alkyl group having 1 to 4 carbon atoms. Examples of Rf include —CₘF₂ₘ₊₁ and —(CF₂)ₘH in which m is an integer of 4 to 12.

It is assumed that the use of a fluoroalkyl group or a perfluoroalkyl group of Rf, containing at least three fluorine atoms forms a recording layer having a distribution of a fluorine atom concentration in the layer thickness direction, which lowers the heat-transfer rate of the recording layer and inhibits exposure unevenness of an exposure device, due to multi-channeling corresponding to high productivity. To control the foregoing concentration distribution, the number of fluorine atoms per monomer unit is effective and is preferably at least 3, more preferably at least 6 and still more preferably at least 9. In the range described above, a specific copolymer is oriented on the surface, resulting in superior ink affinity. The fluorine atom content of a specific copolymer is preferably from 5 to 30 mmol and more preferably from 8 to 25 mmol/g in terms of enhancement of surface orientation of the copolymer and balance between enhanced developability and ink affinity.

Acryl resins described above are usable as the other copolymerizing component. Examples thereof include an acrylate, a methacrylate, an acrylamide, a methacrylamide, a styrene and a vinyl. Of these are preferred an acrylate, a methacrylate, an acrylamide and a methacrylamide.

The average molecular weight of a fluoroalkyl-containing acryl resin is usually from 3,000 to 20,000 and preferably from 6,000 to 100,000.

A fluoroalkyl-containing acryl resin is incorporated to the lower or upper layer preferably in an amount of 0.01 to 50%, more preferably 0.1 to 30%, and still more preferably 1 to 15% by mass in terms of image unevenness, sensitivity and development latitude. When the light-sensitive layer is formed of two layers, incorporation to the upper layer is preferred in terms of development inhibiting capability and inhibition of dissolution due to chemicals used in printing.

Examples of a specific structure of a fluoroalkyl containing acryl resin are shown below, in which numerals in the formula indicate a molar ration of respective monomer components.

| | | | Mw (×10⁴) |
|---|---|---|---|
| P-1 | 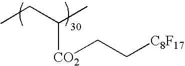 | 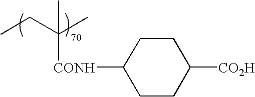 | 3.6 |
| P-2 | 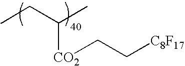 | 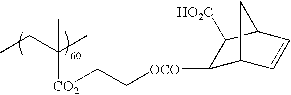 | 5.2 |
| P-3 | 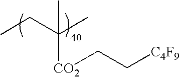 | 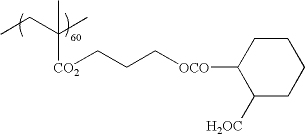 | 2.8 |
| P-4 | 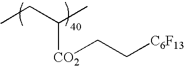 | 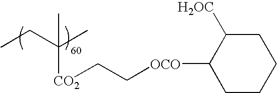 | 2.6 |
| P-5 | 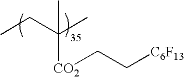 | 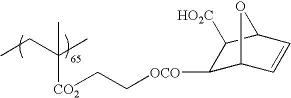 | 3.5 |
| P-6 | 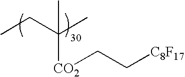 | 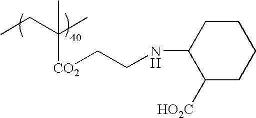 | 4.1 |
| | 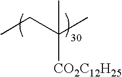 | | |
| P-7 | 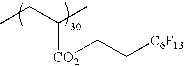 | 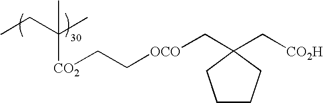 | 5.2 |
| | 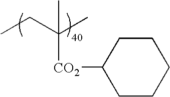 | | |
| P-8 | 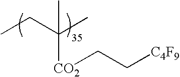 | 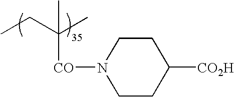 | 2.6 |
| | 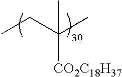 | | |
| P-9 | 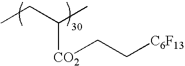 | 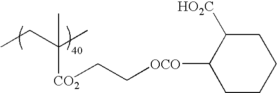 | 1.5 |
| | 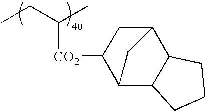 | | |
| P-10 | 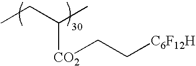 | 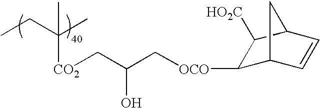 | 3.8 |
| | 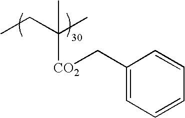 | | |
| P-11 | 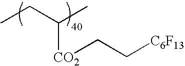 | 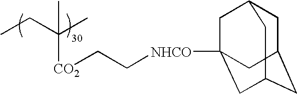 | 4.2 |
| | 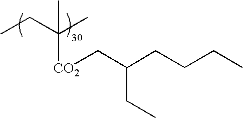 | | |
| P-12 | 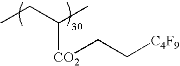 | 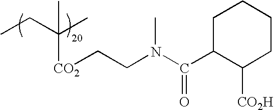 | 5.1 |
| | 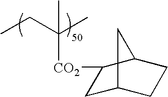 | | |
| P-13 | 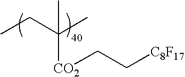 | 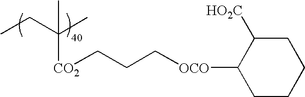 | 3.0 |
| | 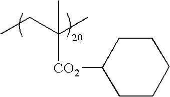 | | |
| P-14 | 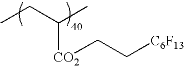 | 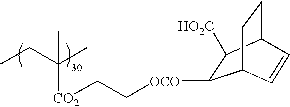 | 2.5 |
| | 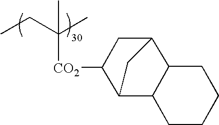 | | |
| P-15 | 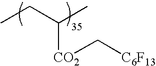 | 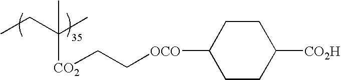 | 1.9 |
| | 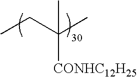 | | |
| P-16 | 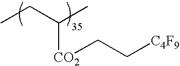 | 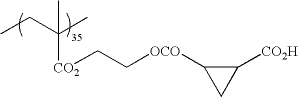 | 1.2 |
| | 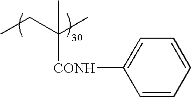 | | |
| P-17 | 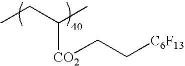 | 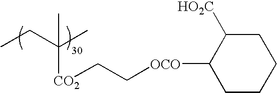 | 1.8 |
| | 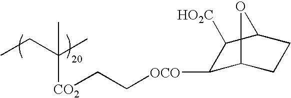 | 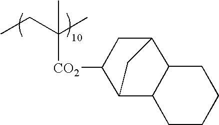 | |
| P-18 | 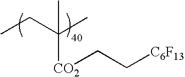 | 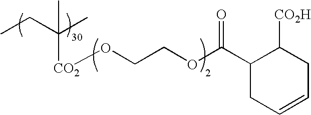 | 3.1 |
| | 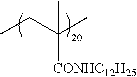 | | |
| P-19 | 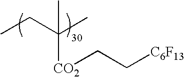 | 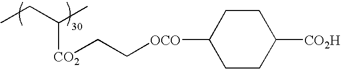 | 1.9 |
| | 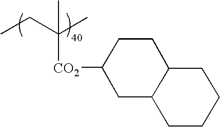 | | |
| P-20 | 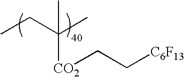 | 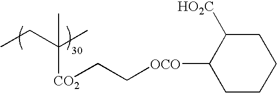 | 2.1 |
| | 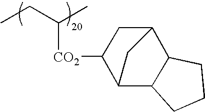 | 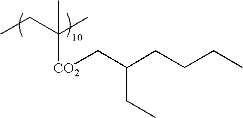 | |
| P-21 | 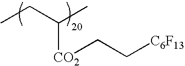 | 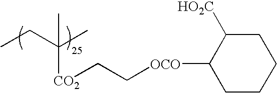 | 1.9 |
| | 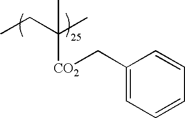 | 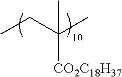 | |
| P-22 | 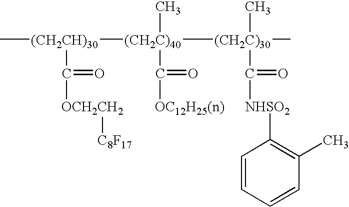 | | |
| P-23 | 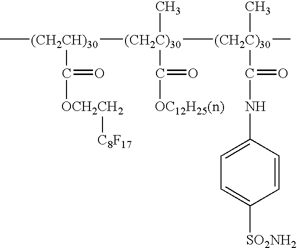 | | |
| P-24 | 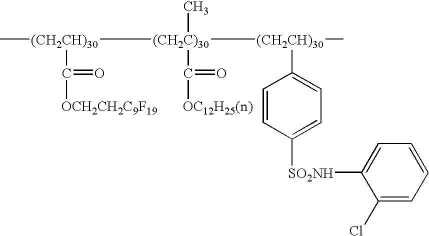 | | |
| P-25 | 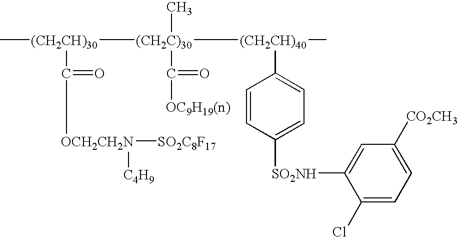 | | |
| P-26 | 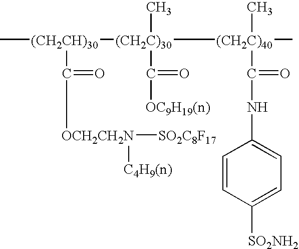 | | |
| P-27 | 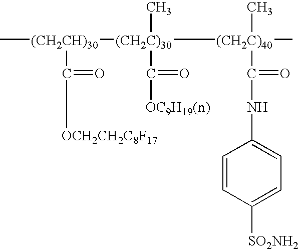 | | |
| P-28 | 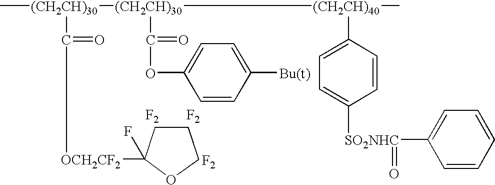 | | |
| P-29 | 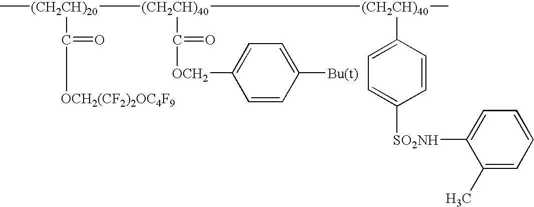 | | |
| P-30 | 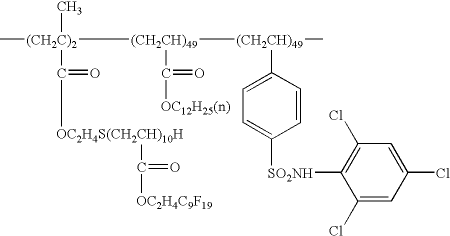 | | |
| P-31 | 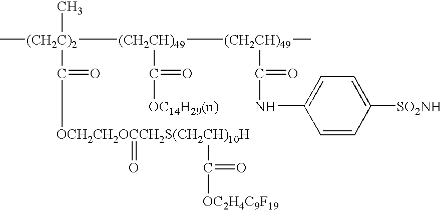 | | |
| P-32 | 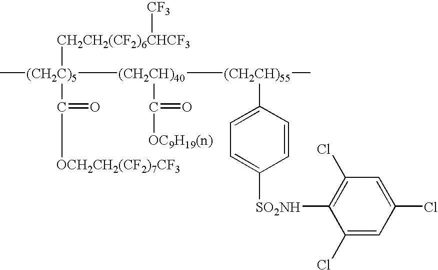 | | |
| P-33 | 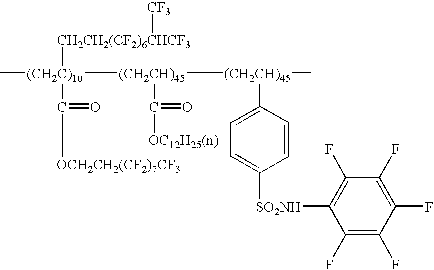 | | |
| P-34 | 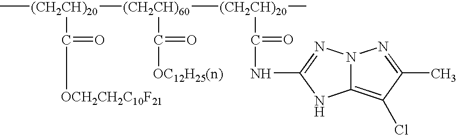 | | |
| AP-1 | 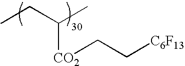 | 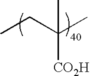 | 2.1 |
| | 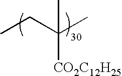 | | |
| AP-2 | 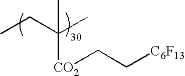 | 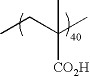 | 1.9 |
| | 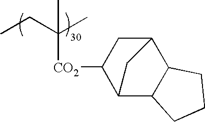 | | |
| AP-3 | 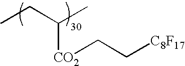 | 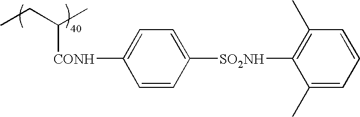 | 3.5 |
| | 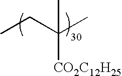 | | |
| AP-4 | 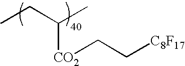 | 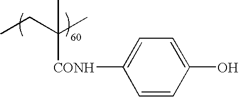 | 4.2 |
| | 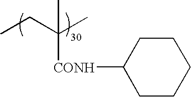 | | |
| AP-5 | 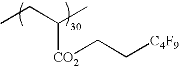 | 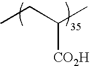 | 2.9 |
| | 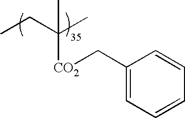 | | |
| AP-6 | 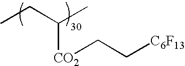 | 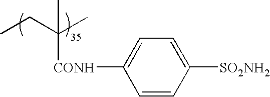 | 3.6 |

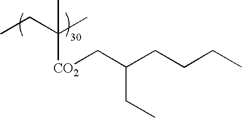

Effects of the fluoroalkyl containing acryl resin are not clear but it is presumed that alkali-soluble resin layers are provided on the support and incorporation of an acid-decomposable compound or a acid-generating compound to the lower layer results in enhanced sensitivity and development latitude. Further, it is presumed that the fluoroalkyl containing acryl copolymer contained in the upper or lower layer exhibits a relatively low heat-transfer rate which is inherent to a fluororesin and its combination with the foregoing acid-decomposable or acid-generating inhibits heat transfer to the surrounding, whereby high productivity or an improvement of image unevenness in high-precise exposure is achieved. It is therefore assumed that image unevenness, sensitivity, development latitude and chemical resistance are compatible in the constitution of the invention.

Of the afore-mentioned resins are preferred an alkali-soluble phenol resin and a vinyl resin which were proven in printing plates. A novolac resin is specifically preferred among phenol resins and an acryl resin and acetal resin is specifically preferred among vinyl resins.

The resin of the invention, which contains a polymerizable group such as a double bond at one or more sites of the substituent derived from the afore-mentioned cyclic ureido compound, specifically at the site of —NH group or R₁, R₃ or R₄, is formed through polymerization, singly or in combination with other monomers. The resin, which also contains a reactive group or polar groups at one or more sites of the backbone of the resin or the substituent derived from the cyclic ureido compound, is modified through addition reaction of the substituent derived from the cyclic ureido compound. The foregoing polymerization or modification is not specifically limited but is performed according to conventional methods.

A novolac resin containing a cyanuric acid group (or a group derived from cyanuric acid), for example, can be synthesized by linking a cyanuric acid derivative having a functional group to a novolac resin through a compound containing at least two functional groups capable of forming a bond to both. As the cyanuric acid derivative having a functional group are cited cyanuric acid derivatives described earlier and a condensation product of 4-hydroxybenzaldehyde and cyanuric acid. As the compound containing at least two functional groups are cited a diisocyanate compound, a polyisocyanate compound, a dibasic acid chloride compound and a diglycidyl compound.

A vinyl resin containing a cyanuric acid group (or group derived from cyanuric acid) can be obtained, for example, by a method (method A of copolymerization reaction) in which, as illustrated in the following reaction formula (I), a vinyl monomer (a) containing an aldehyde group and a cyanuric acid (b) or its derivative are reacted to synthesize a vinyl monomer (c) containing a cyanuric acid group, followed by copolymerization of the vinyl monomer (c) with other vinyl monomer. Alternatively, a vinyl monomer (a) containing an aldehyde group and other vinyl monomer are copolymerized to form a vinyl resin containing an aldehyde group, which is further reacted with cyanuric acid (b) or its derivative (method B of modification).

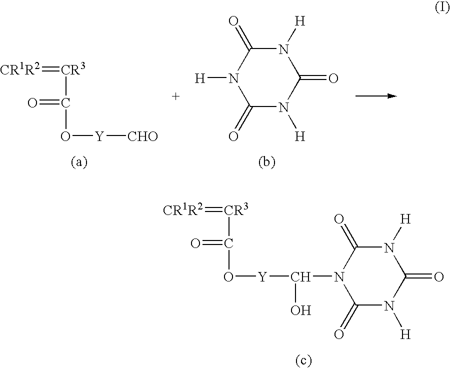

As a vinyl monomer (a) containing a an aldehyde group is usable any compound containing a vinyl-polymerizable unsaturated bond and an aldehyde group. Examples thereof include a condensation product of hydroxybenzaldehydes and (meth)acrylic acid chloride, an addition product of hydroxybenzaldehydes and methacryloyloxyethylisocyanate, and an addition product of glycidyl(meth)acrylate and carboxybenzaldehydes. Herein, hydroxybenzaldehydes include, for example, 2-hydroxybenzaldehyde, 3-hydroxybenzaldehyde, 4-hydroxybenzaldehyde, 3-methoxy-2-hydroxybenzaldehyde, 4-methoxy-3-hydroxybenzaldehyde, 3-methoxy-4-hydroxybenzaldehyde, 5-chloro-2-hydroxybenzaldehyde and 3,5-di-tert-butyl-4-hydroxybenzaldehyde. Of these, 4-hydroxybenzaldehyde is suitably used in the invention.

In the vinyl resin containing a cyanuric acid group, the vinyl monomer (a) containing an aldehyde group of the reaction formula (I) may be replaced by acrolein or methacrolein as a vinyl monomer containing an aldehyde group. Further, as a vinyl resin containing a cyanuric acid group is cited a vinyl resin having a constitution unit represented by the following formula (VP):

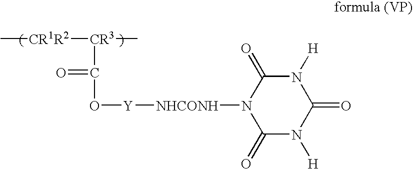

wherein R¹ and R² are each a hydrogen atom, a halogen atom, an alkyl group, an aryl group, or a carboxyl group or its salt; R³ is a hydrogen atom, a halogen atom, an alkyl group or an aryl group; Y is a divalent linkage group. Y is, for example, an alkylene group or a phenylene group, each of which may be substituted.

The vinyl resin having a constitution unit represented by formula (VP) can be obtained, for example, by a method (method A of polymerization reaction) in which, as shown in the following reaction formula (II), a vinyl monomer (d) containing an isocyanate group and 5-aminocyanuric acid (e) are reacted to form a vinyl monomer (f) containing a cyanuric acid group and the formed vinyl monomer (f) containing a cyanuric acid group is copolymerized with other vinyl monomer; alternatively, a vinyl resin containing an isocyanate group is reacted with 5-aminocyanuric acid (method B of modification reaction).

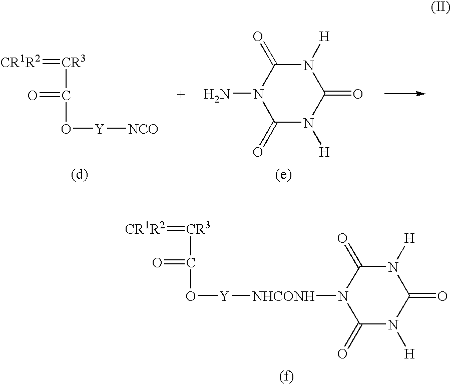

In the resin of invention, the substituent derived from a cyclic ureido compound preferably accounts for 3 to 80% by mass of the resin components, and more preferably 5 to 50% by mass. Effects of the invention are remarkably displayed in such a range. Component(s) other than the substituent derived from a cyclic ureido compound may be introduced within the range of not impairing the effects of the invention. Specifically, since the resin of the invention is used for printing plate material which is developable in an alkali developer, an alkali-soluble resin is preferred and it is preferred to introduce a substituent group having an acidic group such as a carboxyl group, a phenolic hydroxy group, a sulfonic acid group, a phosphoric acid group, a sulfonamido group or an active imido group.

The resin of the invention is contained preferably in an amount of from 10 to 90% by mass of the light-sensitive layer, and more preferably from 30 to 80% by mass. A range of 10 to 90% by mass can achieve enhanced sensitivity and development latitude without deteriorating abrasion resistance.

When the light-sensitive layer of a printing plate material is comprised of two or more layers, the resin of the invention may be used in any layer but the light-sensitive layer is comprised preferably of two layers. When the light-sensitive layer is comprised of two layers, the resin may be used in any of the upper and lower layers. A phenol resin or a novolac resin is used preferably in the upper layer. These resins, which are superior in mechanical strength, are contemplated to be advantageous in plate life or abrasion resistance. When the resin of the invention is used in the upper layer, the upper layer, which is required to be more soluble than the lower layer, preferably contains an acryl resin having a sulfonamido group or a phenolic hydroxyl group.

When used in the lower layer, a vinyl resin, specifically, an acryl resin or an acetal resin is preferably used. These resins, which are superior in solubility in an alkaline developer and resistance to chemicals such as washing oil, are contemplated to be superior in sensitivity, development latitude and chemical resistance.

When the light-sensitive layer is comprised of two layers, the resin of the invention preferably accounts for at least 40% by mass (more preferably, at least 70%) of the lower or upper layer.

The resins of the invention may be used singly or in combination. An alkali-soluble resin which has no substituent derived from the cyclic ureido compound of formulas (1) to (5) may used in combination with the resin of the invention.

### Infrared-Absorbing Compound:

Infrared-absorbing compounds used invention refer to those which exhibit light absorption in the infrared range of 700 nm or more, preferably from 750 to 1200 nm and display photothermal conversion capability for the light at a wavelength within this range. Specifically, there can be used various pigments or dyes which generate heat upon absorption of light of this wavelength region.

The infrared absorbing compounds may be used in combination and when the light-sensitive layer is comprised of two layers, they may be used either one or both of the lower and upper layers. The use in the lower and upper layers is preferred in terms of sensitivity and development latitude.

### Pigment:

Pigments are usable and commercially available ones can be suitably used, including those which are described in “Ganryo Binran (Pigment Handbook)” (Revised Edition, Nippon Ganryogijutsu Kyokai, Seibundo-Shinkosha), “Color Index Binran (Color Index Handbook), “Saishin Ganryo Oyogijutsu” (CMC Publisher, 1986) and “Insatsu Ink Gijutsu” (CMC Publisher, 1984). Varieties of pigments include black pigments, yellow pigments, orange pigments, red pigments, brown pigments, violet pigments, blue pigments, fluorescent pigments, metallic powder pigments and polymer binding dyes. Specific examples include insoluble azo pigments, azo lake pigments, condensed azo pigments, chelate azo pigments, phthalocyanine pigments, anthraquinone pigments, perylene and perynone pigments, thioindigo pigments, quinacrydone pigments, dioxazine pigments, isoindolinone pigments, quinophthalone pigments, dyes lake pigments, azine pigments, nitroso pigments, nitro pigments, natural pigments, fluorescent pigments, inorganic pigments, and carbon black.

The particle size of pigments is preferably from 0.01 to 10 μm, more preferably from 0.05 to 1 μm, and still more preferably from 0.1 to 1 μm.

Dispersing techniques known in ink manufacturing or toner manufacturing can disperse pigments. Examples of dispersing machines include an ultrasonic homogenizer, sand mill, atriter, pearl mill, ball mill, impeller, disperser, KD mill, colloid mill, dynatron, three-bar roll mill, and pressure knader. Details are described in “Saishin Ganryo Oyogijutsu” (CMC Publisher, 1986).

Pigments are contained preferably in an amount of 0.01 to 10% by mass, based on total solids constituting the light-sensitive layer and more preferably from 0.1 to 5% by mass in terms of homogeneity and durability of the light-sensitive layer.

### Dye:

There are usable commercially available dyes and those known in the literature (for example, “Senryo Binran” edited by Yuki Gosei Kagaku Kyoukai, 1970). Secific examples thereof include azo dyes, metal complex dyes, pyrazolone dyes, anthraquinone dyes, phthalocyanine dyes, carbonium dyes, quinoneimine dyes, methine dyes, and cyanine dyes. In the invention, of these compounds are preferred pigments, dyes or compounds absorbing infrared light or near-infrared light, which are suitable for employment in infrared or near infrared laser.

Specific examples of dyes or compounds absorbing infrared or near infrared light (which are also denoted as infrared- or near infrared-absorbing dyes or compounds) include cyanine dyes described in JP-A Nos. 58-125246, 59-84356, 59-202829 and 60-78787; methine dyes described in JP-A Nos. 58173696, 58-181690 and 58-194595; naphthoquinone dyes described in 58-112793, 58-224793, 59-48187, 59-73996, 60-52940 and, 60-63744; squarilium dyes described in JP-A No. 58-112792; and cyanine dyes described in British Patent No. 434,875. Near-infrared absorbers described in U.S. Pat. No. 5,156,938 are used as a dye. There are also preferably used substituted arylbenzo(thio)pyrylium described in U.S. Pat. No. 3,881,924; trimethinethiapyrylium salt described in JP-A No. 57-142645 (U.S. Pat. No. 4,327,169); pyrylium compounds described in JP-A Nos. 58-181051, 58-220143, 59-41363, 59-84248, 59-84249, 59-146063 and 59-146061; cyanine dyes described in JP-A No. 59-59-216146; pentamethinethiopyrylium salts described in U.S. Pat. No. 4,283,475; pyrylium compounds described in JP-B Nos. 5-13514 and 5-19702; Epolight III-178, Epolight III-130 and Epolight III-125.

Of these dyes are specifically preferred cyanine dyes, phthalocyanine dyes, oxonol dyes, squarilium dyes, pyrylium dyes, thiopyrylium dyes and nickel thiolato complexes.

Further, a cyanine dye represented by the following formula (CD), which provides high interaction with an alkali-soluble resin and is superior in stability and economic feasibility, is preferred for use in image forming material relating to the invention:

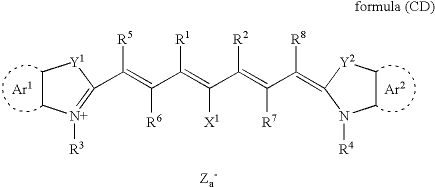

wherein X¹ is a hydrogen atom, a halogen atom, —NPh₂, —X²-L¹ or a group represented by the following formula

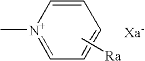

in which Xa⁻ is the same as defined in Za⁻ described later and Ra is a hydrogen atom or substituent selected from the group consisting of an alkyl group, an aryl group, a substituted or unsubstituted amino group and a halogen atom; Ph is a phenyl group; X₂ is an oxygen atom or a sulfur atom; L¹ is a hydrocarbon group having 1 to 12 carbon atoms, an aromatic ring having a heteroatom or a hydrocarbon group having a heteroatom and 1 to 12 carbon atoms, in which the heteroatom is N, S, O, a halogen atom or Se; R¹ and R² are each independently a hydrocarbon group having 1 to 12 carbon atoms, provided that R¹ and R² may combine with each other to form a 5- or 6-membered ring; Ar¹ and Ar², which may be same or different, are each an aromatic hydrocarbon group which may be substituted.

Preferred aromatic hydrocarbon groups include a benzene ring and naphthalene ring, and preferred substituents include a hydrocarbon group having not more than 12 carbon atoms, a halogen atom, and an alkoxy group having not more than 12 carbon atoms. Y¹ and Y², which may be the same or different are each a sulfur atom or a dialkylmethine group having not more than 12 carbon atoms. R³ and R⁴, which may be the same or different or may be substituted, are each a hydrocarbon group having not more than 20 carbon atoms. Examples of a preferred substituent include an alkoxy group having not more than 12 carbon atom, a carboxy group and a sulfo group. R⁵, R⁶, R⁷ and R⁸, which may be the same or different, are each a hydrogen atom or a hydrocarbon group having not more than 12 carbon atoms, and preferably a hydrogen atom in terms of availability. Za⁻ is a counter anion, provided that when a cyanine dye of formula (CD) has an anionic substituent in the molecule and does not need to be compensated for charge, Za⁻ is not necessary. Za⁻ is preferably a halogen ion, a perchlorate ion, a tetrafluoroborate ion, a hexfluorophosphate ion and a sulfonic acid ion, and more preferably a perchlorate ion hexafluorophosphate ion and an arylsulfonic acid ion.

Specific examples of the cyanine dye represented by formula (CD) are shown below.

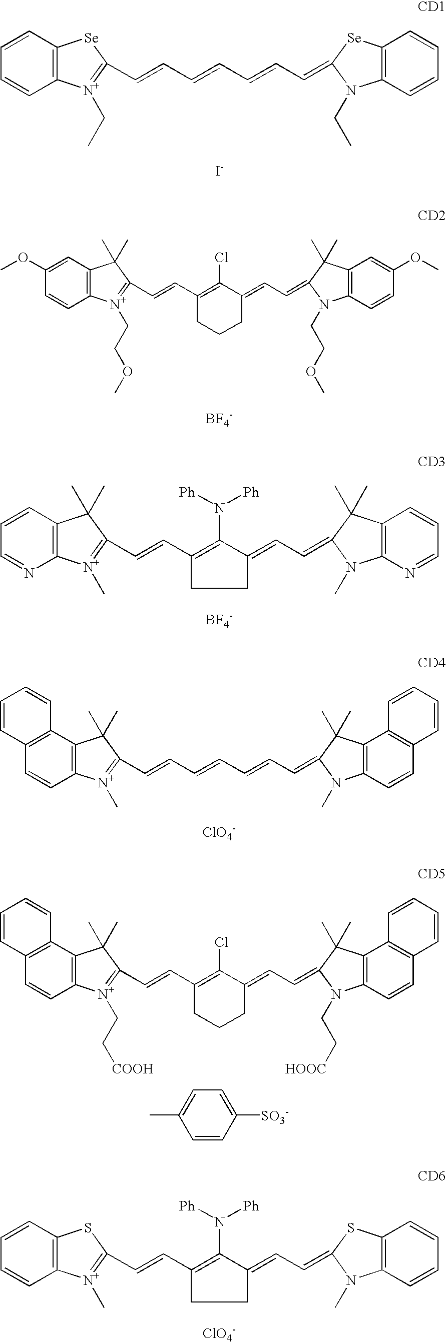

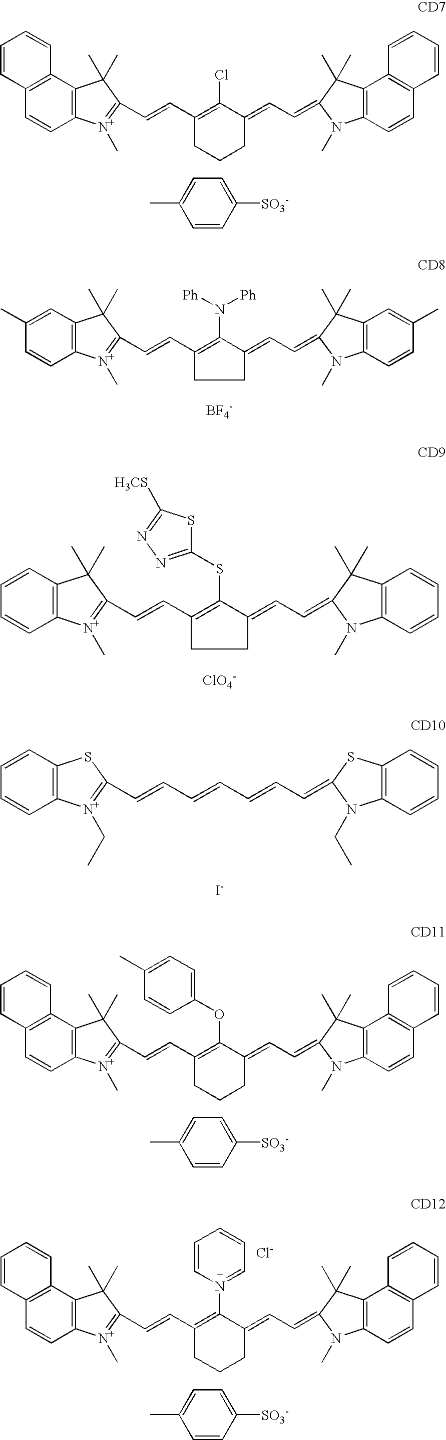

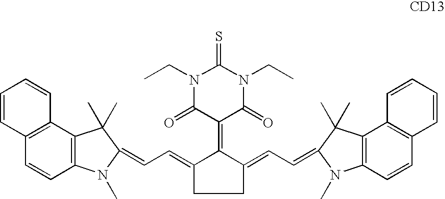

In addition the foregoing examples of cyanine dyes of formula (CD) are also cited those described in paragraph [0017]-[0019] of JP-A No. 2001-133969, those described in paragraph [0012]-[0038] of JP-A 2002-40638, and those described in paragraph [0012]-[00231 of JP-A No. 2002-23360.

An infrared absorption dye is contained preferably in an amount of from 0.01 to 30% by mass, based on total solids constituting the light-sensitive layer, more preferably from 0.1 to 10% by mass and still more preferably from 0.1 to 5% by mass in terms of sensitivity, chemical resistance and plate life.

### Acid-Decomposable Compound

The lower light-sensitive layer preferably contains an acid-decomposable compound of formula (6):

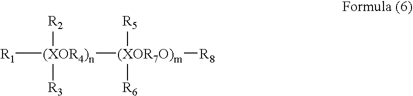

wherein n is an integer of 1 or more and mi is an integer of 0, 1 or more; X is a carbon atom or a silicon atom; R₄ is an ethyleneoxy group or a propyleneoxy group; R₂ and R₅ are each a hydrogen atom, an alkyl group or an aryl group, and R₃ and R₆ are each an alkyl group or an aryl group, provided that R₂ and R₃ or R₅ and R₆ may combine with each other to form a ring which may be substituted; R₇ is an alkylene group; R₁ is a hydrogen atom, an alkyl group, an aryl group, an alkoxy group an aryloxy group or a halogen atom; R₈ is a hydrogen atom or —XR₂R₃R₁ or —XR₅R₆R₁.

Among acid-decomposable compounds of formula (6), acetals are synthesized preferably by condensation of aldehydes or ketones such as dimethylacetal or diethylacetal with a diol compound such as ethylene glycol, diethylene glycol, triethylene glycol, tetraethylene glycol, pentaethylene glycol, polyethylene glycol, propylene glycol, dipropylene glycol, tripropylene glycol, tetrapropylene glycol, pentapropylene glycol, polypropylene glycol and a polyethylene glycol-propylene glycol copolymer, in terms of yield.

Examples of such an aldehyde include acetaldehyde, chloral, ethoxyacetaldehyde, benzyloxyacetaldehyde, phenylacetaldehyde, diphenylacetaldehyde, phenoxyacetaldehyde, propionealdehyde, 2- or 3-phenylaldehyde, isobutoxypivalic aldehyde, benzyloxypivalic aldehyde, 3-ethoxypropanal, 3-cyano-propanal, n-butanal, isobutanol, 3-chloro-butanal, 3-methoxy-butanal, 2,2-dimethyl-4-cyano-butanal, 2- or 3-ethylbutanal, n-pentanal, 2- or 3-methylpentanal, 2-bromo-3-methyl-pentanal, n-hexanal, cyclopentanecarbaldehyde, n-heptanal, cyclohexanecarbaldehyde, 1,2,3,6-tetrahydro-benzaidehyde, 3-ethylpentanal, 3- or 4-methyl-hexanal, n-octanal, 2- or 4-ethyl-hexanal, 3,5,5-trimethylhexanal, 4-methylheptanal, 3-ethyl-n-heptanal, decanal, dodecanal, crotonic aldehyde, benzaldehyde, 2-, 3- or 4-bromobenzaldehyde, 2,4- or 3,4-dichloro-benzaldehyde, 4-methoxt-benzaldehyde, 2,3- or 2,4-dimethoxy-benzaldehyde, 2-, 3- or 4-fluoro-benzaldehyde, 2-, 3- or 4-methyl-benzaldehyde, 4-isopropyl-benzaldehyde, 3- or 4-tetrafluorothyl-benzaldehyde, 1- or 2-naphthoaldehyde, furfural, thiophene-2-aldehyde, terephthalaldehyde, piperonal, 2-pyridinecarbaldehyde, p-hydroxy-benzaldehyde, 3,4-dihydroxy-benzaldehyde5-methyl-furaldehyde, and vanillin.

Examples of ketones include phenylacetone, 1,3-diphenylacetone, 2,2-diphenylacetone, chloro or bromo-acetone, benzylacetone, methyl ethyl ketone, benzyl-propyl ketone, ethyl benzyl ketone, benzyl methyl ketone, isobutyl ketone, 5-methyl-hxane-2-one, 2-methyl-pentane-2-one, 2-methyl-pentane-3-one, hexane-2-one, pentane-3-one, 2-methyl-butane-3-one, 2,2-dimethyl-butane-3-one, 5-methyl-heptane-3-one, octane-2-one, octane-3-one, octane-4-one, nonane-2-one, nonane-3-one, nonane-5-one, heptane-2-one, heptane-3-one, heptane-4-oneundecane-2-one, undecane-4-one, undecane-5-one, unecane-6-one, dodecane-2-one, dedecane-3-one, tridecane-2-one, tridecane-3-one, tridecane-7-one, dinonyl ketone, dioctyl ketone, 2-methyl-octane-3-one, cyclopropyl methyl ketone, ecane-2-one, decane-3-one, decane-4-one, methyl-α-naphthyl-ketone, didecyl ketone, diheptyl ketone, dihexyl ketone, acetophenone, 4-methoxy-acetophenone, 4-chloro-acetophenone, 2,4-dimethyl-acetophenone, 2-, 3- or 4-fluoroacetophenone, 2,3- or 4-methylacetphenone, propiophenone, 4-methoxy-propiophenone, butylophenone, valerophenone, benzophenone, 3,4-dihydroxybenzophenone, 2,5-dimethoxybenzophenone, 3,4-dimethoxybenzophenone, 3,4-dimethylbenzophenone, cyclohexanone, 2-phenyl-cyclohexanone, 2-, 3- or 4-methyl-cyclohexanone, 4-t-butyl-cyclohexanone, 2,6-dimethylcyclohexanone, 2-chlorocyclohexanone, cyclopentanone, cycloheptanone, cycloocyanone, cyclononanone, 2-cyclohexene-1-onecyclohexylpropanone, flavanone, cyclohexane-1,4-done, cyclohexane-1,3-dionetropone and isophorone.

Aldehydes or ketones having solubility in water at 25° C. of 1 to 100 g/L is specifically preferred from the viewpoint of prevention of sludge and lowering of resolving power in continuous-processing. Specific examples thereof include benzaldehyde, 4-hydroxybenzaldehyde, 3,4-dihydroxybenzaldehyde, 2-pyridinecarvaldehyde, piperonal, phthalaldehyde, terephthalaldehyde, 5-methyl-2-phthalaldehyde, phenoxyacetaldehyde, phenylacetaldehyde, cyclohexanecarvaldehyde, vaniline, cyclohexanone, cyclohexane-1-0ne, isobutylaldehyde, and pentanal. Of these, cyclohexanone is most stable and preferred.

Silyl ethers can be synthesized through condensation of a silyl compound and a diol compound, as described earlier.

Silyl ethers which is decomposed upon the action of an acid to form a silyl compound exhibiting a solubility in water at 25° C. of 1 to 100 g/L are preferred. Specific examples of a silyl compound include dichlorodimethylsilane, dichlorodiethylsilane, methylphenyldichlorosilane, diphenyldichlorosilane and methylbenzyldichlorosilane.

The foregoing acetals and silyl ethers may be co-condensed with alcohols other than diol compounds. Specific examples of such alcohols include substituted or unsubstituted monoalkyl alcohols such as methanol, ethanol, n-propanol, isopropanol, butanol, pentanol, hexanol, cyclohexanol and benzyl alcohol; glycol ether alcohols such as ethylene glycol monomethyl ether, ethylene glycol monoethyl ether, ethylene glycol monophenyl ether, diethylene glycol monomethyl ether, diethylene glycol monoethyl ether and diethylene glycol monophenyl ether; substituted or unsubstituted polyethylene glycol alkyl ethers and polyethylene glycol phenyl ethers. Examples of a divalent alcohol include pentane-1,5-diol, n-hexane-1,6-diol, 2-ethylhexane-1,6-diol, 2,3-dimethyl-hexane-1,6-diol, heptane-1,7-diol, cyclohexane-1,4-diol, nonane-1,7-diol, nonane-1,9-diol, 3,6-dimethyl-nonane-1,9-diol, decane-1,10-diol, dodecane-1,12-diol, 1,4-bis-(hydroxymethyl)-cyclohexane, 2-ethyl-1,4-bis-(hydroxymethyl)-cyclohexane, 2-methyl-cyclohexane-1,4-diethanol, 2-methyl-cyclohexane-1,4-dipropanol, thio-dipropylene glycol, 3-metylpentane-1,5-diol, dibutylene-glycol, 4,8-bis-(hydroxymethyl)-tricyclodecane, 2-butene-1,4-diol, p-xylene glycol, 2,5-domethyl-hexane-3-yne-2,5-diol, bis-(2-hydroxyethyl)-sulfide, and 2,2,4,4-tetramethylcyclobutane-1,3-diol. In this embodiment, the molar ratio of diol compound inclusive of ethylene glycol and propylene glycol to other alcohol is preferably from 70/30 to 100/0, and more preferably from 85/15 to 100/0.

With respect to the preferred range of molecular weight of an acid-decomposable compound, the weight average molecular weight which is determined by gel permeation chromatography (GPC) is preferably from 500 to 10000, and more preferably from 1000 to 3000.

Acid-decomposable compounds, a compound containing a Si—N bond described in JP-A No. 62-222246, a carbonic acid ester described in JP-A No. 62-251743, an orthotitanic acid ester described in JP-A No. 62-280841, an orthosilic acid ester described in described in JP-A No. 62-280842, a compound containing a C—S bond described in JP-A No. 62-244038, and a compound containing a —O—C(═O)— bond described in JP-A No. 63-231442 may be used in combination.

There will be described synthesis examples of acid-decomposable compounds usable in the invention.

### Synthesis of Acid-Decomposable Compound A1:

1.0 mol of 1,1-dimethoxycyclohexane, 1.0 mol of ethylene glycol, 0.003 mol of p-toluenesulfonic acid hydrate and 500 ml of toluene were reacted with stirring at 100° C. for 1 hr., thereafter, the temperature was gradually raised to 150° C. and the reaction continued at 150° C. for 4 hrs. Methanol formed during the reaction was distilled out. After cooled, the reaction product was sufficiently washed with water and further washed successively with an aqueous 1% NaOH solution and an aqueous 1N NaOH solution. After further washed with an sodium chloride solution and dehydrated with anhydrous potassium carbonate, the reaction product was concentrated under reduced pressure. The product was dried under reduced pressure at 80° C. for 10 hrs. to obtain a wax-form compound. The weight average molecular weight (Mw), determined by GPC was ca. 1200 in term of polystyrene.

### Synthesis of Acid-Decomposable Compound A2:

Similarly to the foregoing acid-decomposable compound A1, synthesis was conducted and a wax-form product was obtained, provided that ethylene glycol was replaced by 1.0 mol of diethylene glycol. The Mw was ca. 2000.

### Synthesis of Acid-Decomposable Compound A3:

Similarly to the foregoing acid-decomposable compound A1, synthesis was conducted and a wax-form product was obtained, provided that ethylene glycol was replaced by 1.0 mol of triethylene glycol. The Mw was ca. 1500.

### Synthesis of Acid-Decomposable Compound A4:

Similarly to the foregoing acid-decomposable compound A1, synthesis was conducted and a wax-form product was obtained, provided that ethylene glycol was replaced by 1.0 mol of tetraethylene glycol. The Mw was ca. 1500.

### Synthesis of Acid-Decomposable Compound A5:

Similarly to the foregoing acid-decomposable compound A1, synthesis was conducted and a wax-form product was obtained, provided that ethylene glycol was replaced by 1.0 mol of dipropylene glycol. The Mw was ca. 2000.

### Synthesis of Acid-Decomposable Compound A6:

Similarly to the foregoing acid-decomposable compound A2, synthesis was conducted and a wax-form product was obtained, provided that 1.0 mol of 1,1-dimethoxycyclohexane was replaced by 1.0 mol of benzaldehyde dimethylacetal. The Mw was ca. 2000.

### Synthesis of Acid-Decomposable Compound A7:

Similarly to the foregoing acid-decomposable compound A2, synthesis was conducted and a wax-form product was obtained, provided that 1.0 mol of 1,1-dimethoxycyclohexane was replaced by 1.0 mol of furaldehyde dimethylacetal. The Mw was ca. 2000.

The content of an acid-decomposable compound is preferably from 0.5 to 50% by mass based on total solids of the composition constituting the lower layer, in terms of sensitivity, development latitude and safelight suitability.

Acid-decomposable compounds may be used singly or in combination. In the case of the light-sensitive layer being composed of two layers, the acid-decomposable compound is contained preferably in the lower light-sensitive layer in terms of sensitivity and development latitude. 200

### Acid Generating Agent:

The light-sensitive layer preferably contains an acid generation agent. The acid generating agent (which is also denoted as a photo acid-generation agent) refers to one which can generate an acid upon exposure to actinic rays, and various compounds and their mixtures are known. For example, BF₄⁻, PF₆⁻, SbF₆⁻² or ClO₄⁻ salt of diazonium, phosphonium, sulfonium or iodonium, organic halogen compounds, orthoquinone diazide sulfonium chloride, organic metal/organic halogen compounds, which form or separate an acid upon exposure to actinic rays, are usable as an acid generating agent.

All organic halogen compounds known as a radical-forming photoinitiator, which are capable of forming a hydrogen halide acid, are usable as an acid generating agent in the invention. There are further cited a compound photolytically generating a sulfonic acid, such as an iminosulfonate described in JP-A No. 3-140109, a disulfone compound described in JP-A No. 61-166544, o-naphthoquinonediazide-4-sulfonic acid halide described in JP-A No. 50-36209 (U.S. Pat. No. 3,969,118) and an o-napthoquinone diazide compound described in JP-A No. 55-62444 (British Patent No. 2,038,801) or JP-B No. 1-11935. There are also usable, as an acid generating agent, cyclohexyl citrate, sulfonic acid alkyl esters such as cyclohexyl p-acetoaminobenzenesulfonate and cyclohexyl p-bromobenzenesulfonate, and alkylsulfonic acid esters described in Japanese Patent Application No. 9-26878.

Examples of compounds forming a hydrogen halide acid include those described in U.S. Pat. Nos. 3,515,552, 3,536,489 and 3,779,778, and West German Patent Application Publication No. 2,243,621; compounds described in West German Patent Application Publication No. 2,610,842, which photolytically generate acids, are also usable. There is also usable o-naphthoquinonediazide-4-sulfonic acid halogenide, as described in JP-A No. 50-36209.

In the invention, organic halogen compounds are preferred as an acid photogenerating agent in terms of sensitivity in image formation by infrared exposure and storage stability of an image forming material. Such organic halogen compounds preferably are triazines having a halogenated alkyl group and oxadiazoles having a halogenated alkyl group, and s-triazines having a halogenated alkyl group are specifically preferred. Specific examples of s-triazines having a halogenated alkyl group include 2-halomethyl-1,3,4-oxadiazole compounds described in JP-A Nos. 54-74728, 55-24113, 55-77742, 60-3626 and 60-138539.

There will be described effective compounds which generate an acid upon exposure to light, heat or radiation.

As effective compounds are cited a trihalomethyl-substituted oxazole derivative represented by general formula (PAG1), a s-triazine derivative represented by general formula (PAG2), a iodonium salt represented by general formula (PAG3), a sulfonium salt represented by general formula (PAG4), a disulfone derivative represented by general formula (PAG5) and an iminosulfonate derivative represented by general formula (PAG6):

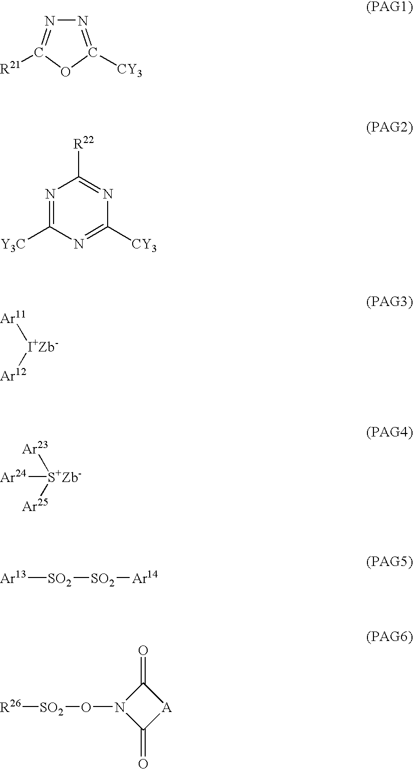

wherein R¹ is a substituted or unsubstituted aryl or alkenyl group; R² is a substituted or unsubstituted aryl, alkenyl or alkyl group or —CY₃ in which Y is a chlorine atom or a bromine atom; Ar¹ and Ar² are each a substituted or unsubstituted aryl group; R³, R⁴ and R⁵ are each independently a substituted or unsubstituted alkyl or aryl group, provided that two of R³, R⁴ and R⁵, or Ar¹ and Ar² may be linked through a single bond or a substituent; Z⁻ is an anionic counter ion; Ar³ and Ar⁴ are each independently a substituted or unsubstituted aryl group; R⁶ is a substituted or unsubstituted alkyl or aryl group; A is a substituted or unsubstituted alkylene, alkenylene or arylene group.

Specific examples of the foregoing compounds are shown below.

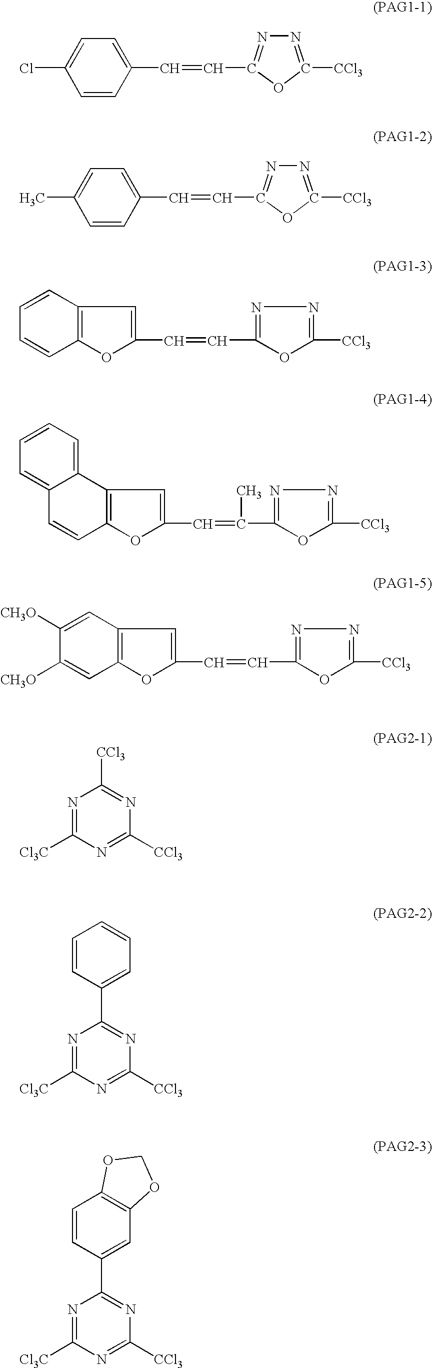

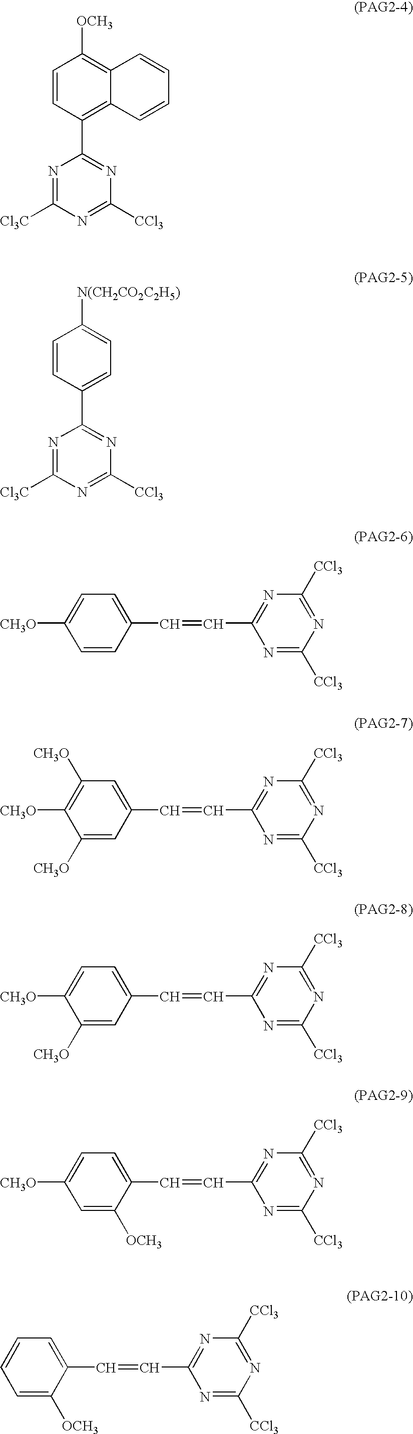

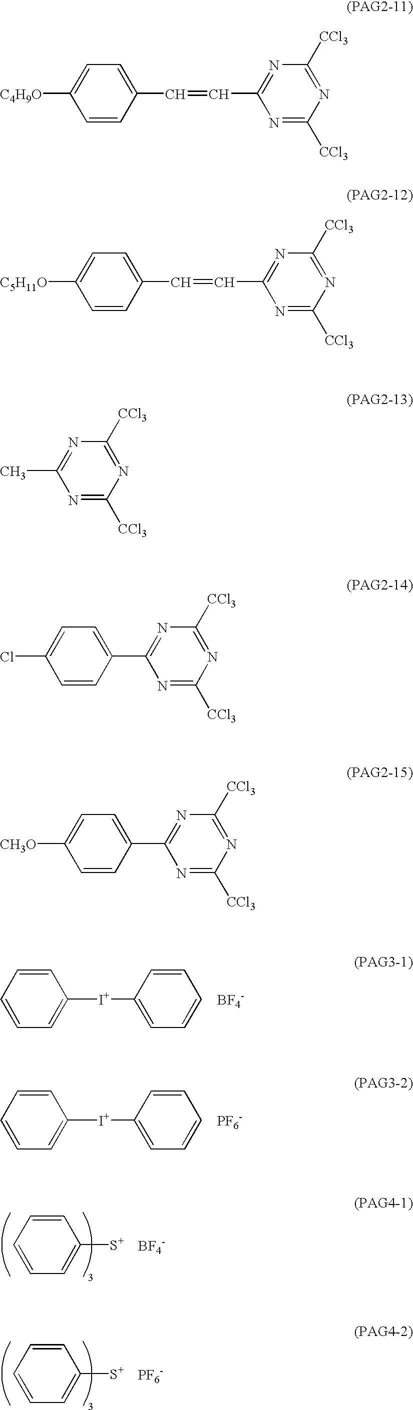

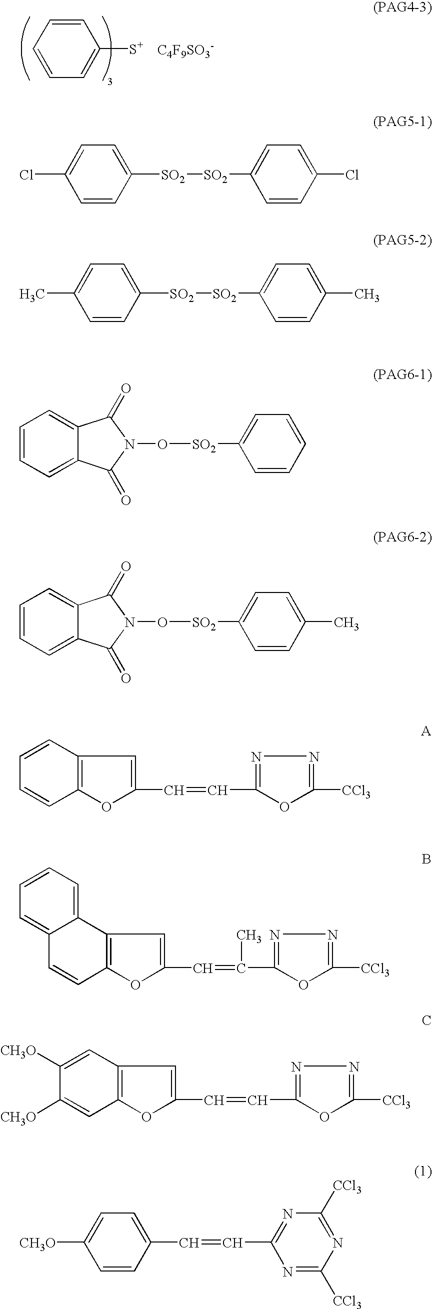

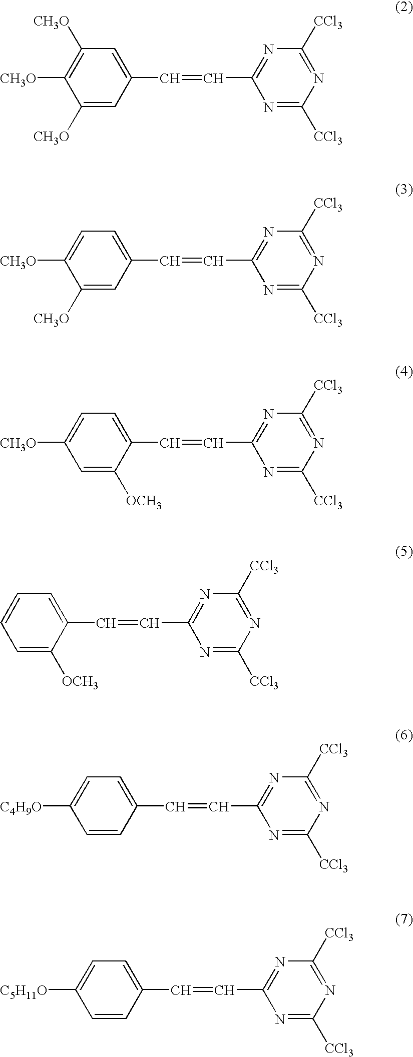

A polymerization initiator described in JP-A 2005-70211, a compound capable of forming a radical described in published Japanese translation of PCT international publication for patent application No. 2002-537419, and polymerization initiators described in JP-A No. 2002-278057 and 2003-5363 are usable as an acid generating agent. There are also optionally usable an onium salt having at least two cationic portions in the molecule, as described in JP-A No. 2003-76010, a N-nitrosoamine compound described in JP-A No. 2001-133966, a radical thermogenerating compound described in described in JP-A No. 2001-343742, acid or radical thermogenerating agents described in JP-A No. 2002-6482, a borate compound described in JP-A No. 2002-116539, acid or radical thermogenerating agents described in JP-A No. 2002-148790, a polymerization photo- or thermo-initiator having a polymerizable unsaturated group, described in JP-A No. 2002-207293, an onium salt having two or more valent anion as a counter ion, described in JP-A No. 2002-268217, a sulfonylsulfone compound having a specific structure, described in JP-A No. 2002-328465, and a radical generating compound described in JP-A No. 2002-341519.

A compound represented by the following formula (2), which is superior in safelight suitability, is preferred as an acid generating agent:

R¹—C(X)₂—C(═O)—R² formula (7)

wherein R¹ is a hydrogen atom, a bromine atom, a chlorine atom, an alkyl group, an aryl group, an acyl group, an alkylsulfonyl group, an arylsulfonyl group, an iminosulfonyl group or a cyano group; R² is a hydrogen atom or a univalent organic substituent, provided that R¹ and R₂ may combine with each other to form a ring; X is a bromine atom or a chlorine atom.

In formula (7), R¹ is preferably a hydrogen atom, a bromine atom or a chlorine atom in terms of sensitivity and the organic substituent of R² is not specifically limited so long as the compound of formula (7) generates a radical upon exposure to light but —R² is preferably —O—R³ or —NR⁴—R³ in which R³ is a hydrogen atom or a univalent organic substituent and R⁴ is a hydrogen atom or analkyl group. In that case, ), R¹ is preferably a hydrogen atom, a bromine atom or a chlorine atom in terms of sensitivity.

Of compounds of formula (7) is preferred a compound having at least one acetyl group selected from a tribromoacetyl group, a dibromoacetyl group, a trichloroacetyl group and a dichloroacetyl group.

From the viewpoint of synthesis are preferred a compound having at least acetoxy group selected from a tribromoacetoxy group, dibromoacetoxy group, trichloroacetoxy group and a dichloroacetoxy group, which is obtained by the reaction of a uni- or poly-valent alcohol and a corresponding acid chloride, and a compound having at least acetylamido group selected from a tribromoacetylamido group, dibromoacetylamido group, trichloroacetylamido group and a dichloroacetyl group, which is obtained by the reaction of a uni- or poly-valent amine and a corresponding acid chloride. There are also preferably used compounds having at least two of an acetyl group, an acetoxy group and an acetoamide group. These compounds can be readily synthesized under conditions of the conventional esterification or amidization reaction.

The typical synthesis method of compounds of formula (7) is esterification or amidization of alcohol, phenol or an amine derivatives by using a tribromoacetic acid chloride, dibromoacetic acid chloride, a trichloroacetic acid chloride or dichloroacetic acid chloride corresponding the individual structure.

Alcohols, phenols and amines used in the foregoing reaction may be any ones, including, for example, univalent alcohols such as ethanol, 2-butanol and 1-adamantanol; polyvalent alcohols such as diethylene glycol, trimethylolpropane, and dipentaerythritol; phenols such as phenol, pyrogallol, and naphthol; univalent amines such as morpholine, aniline, and 1-aminodecane; and polyvalent amines such as 2,2-dimethylpropylenediamine and 1,12-dodecanediamine.

Specific examples of the compound of formula (7) are shown below.

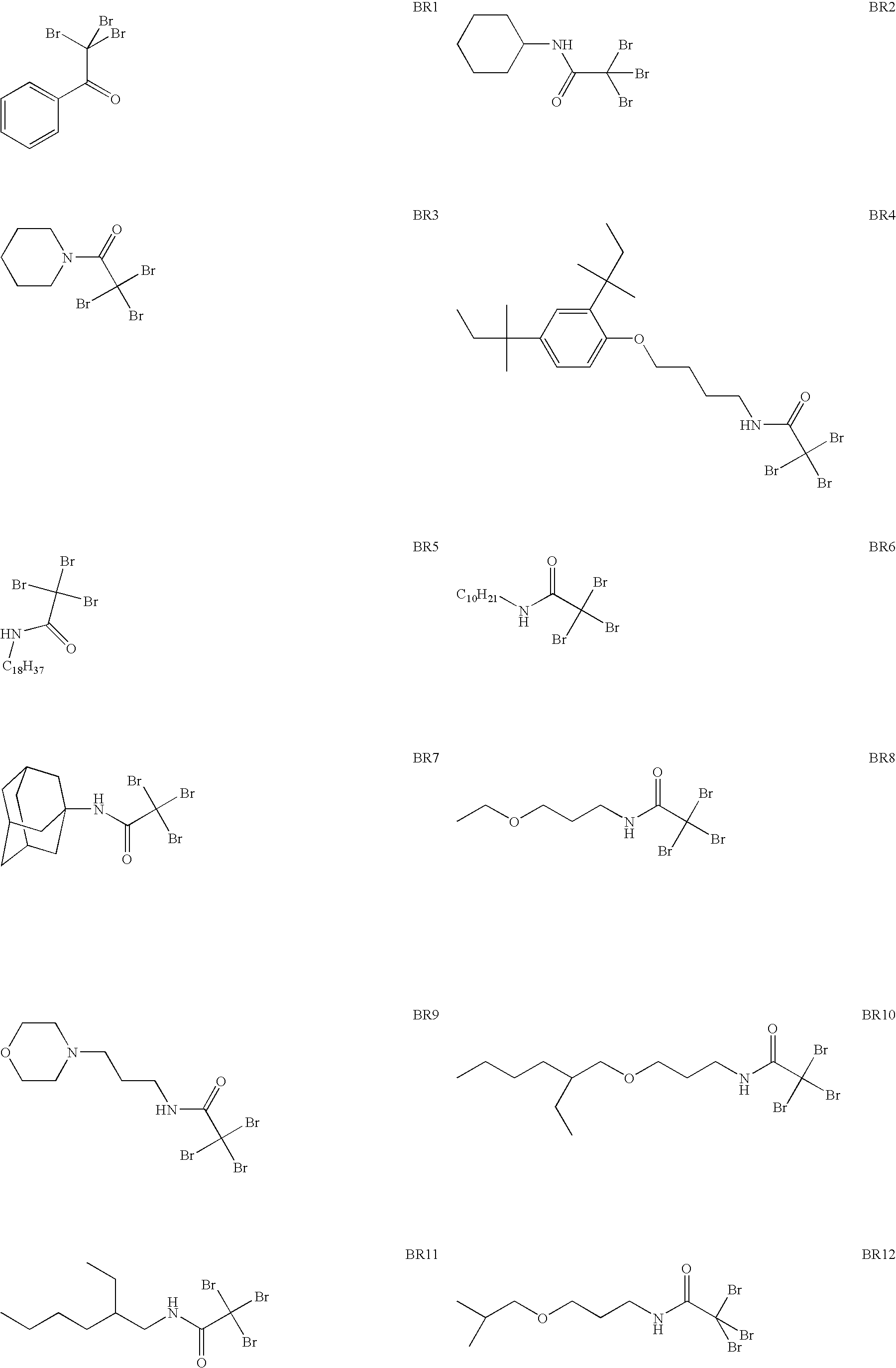

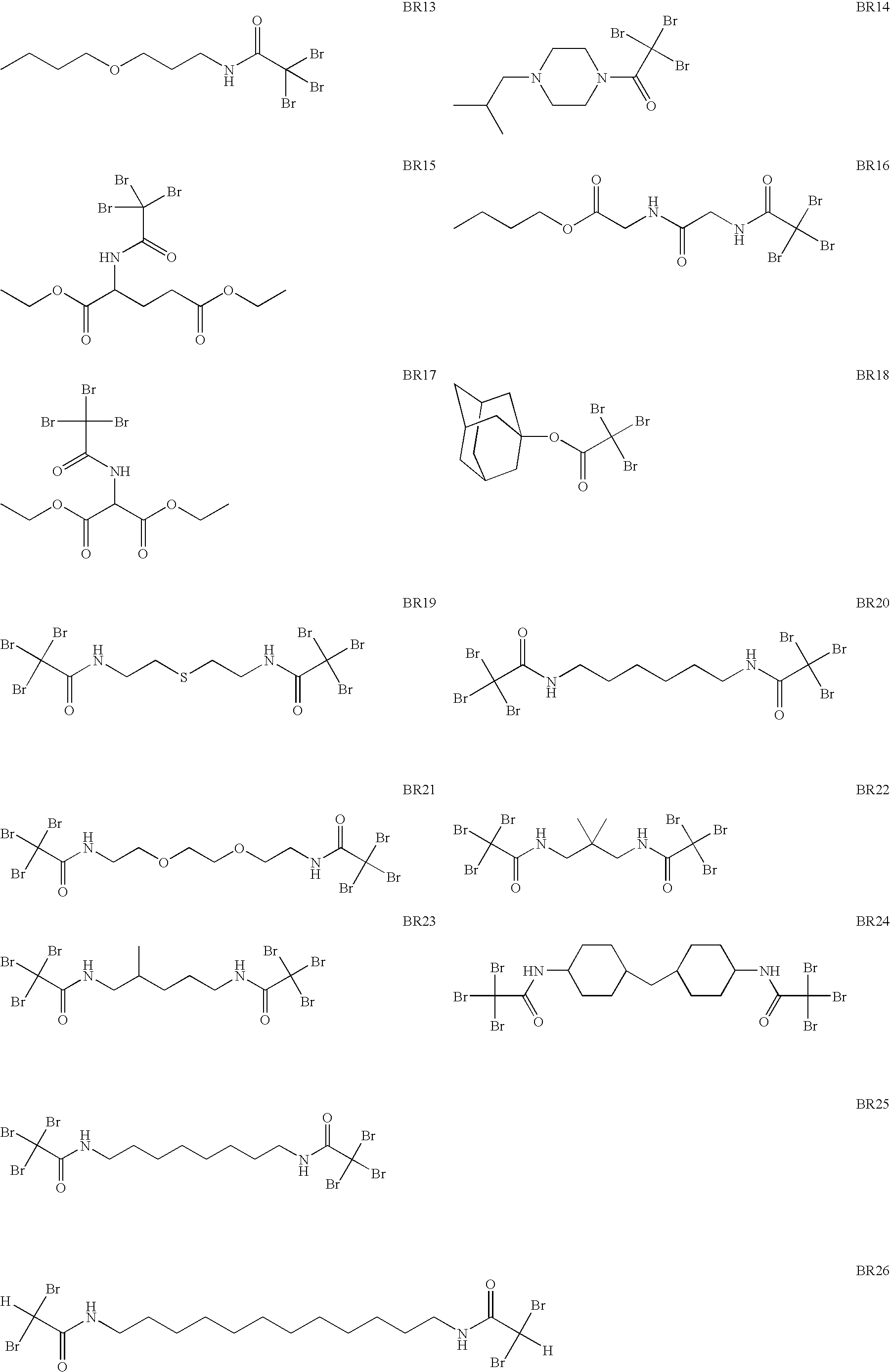

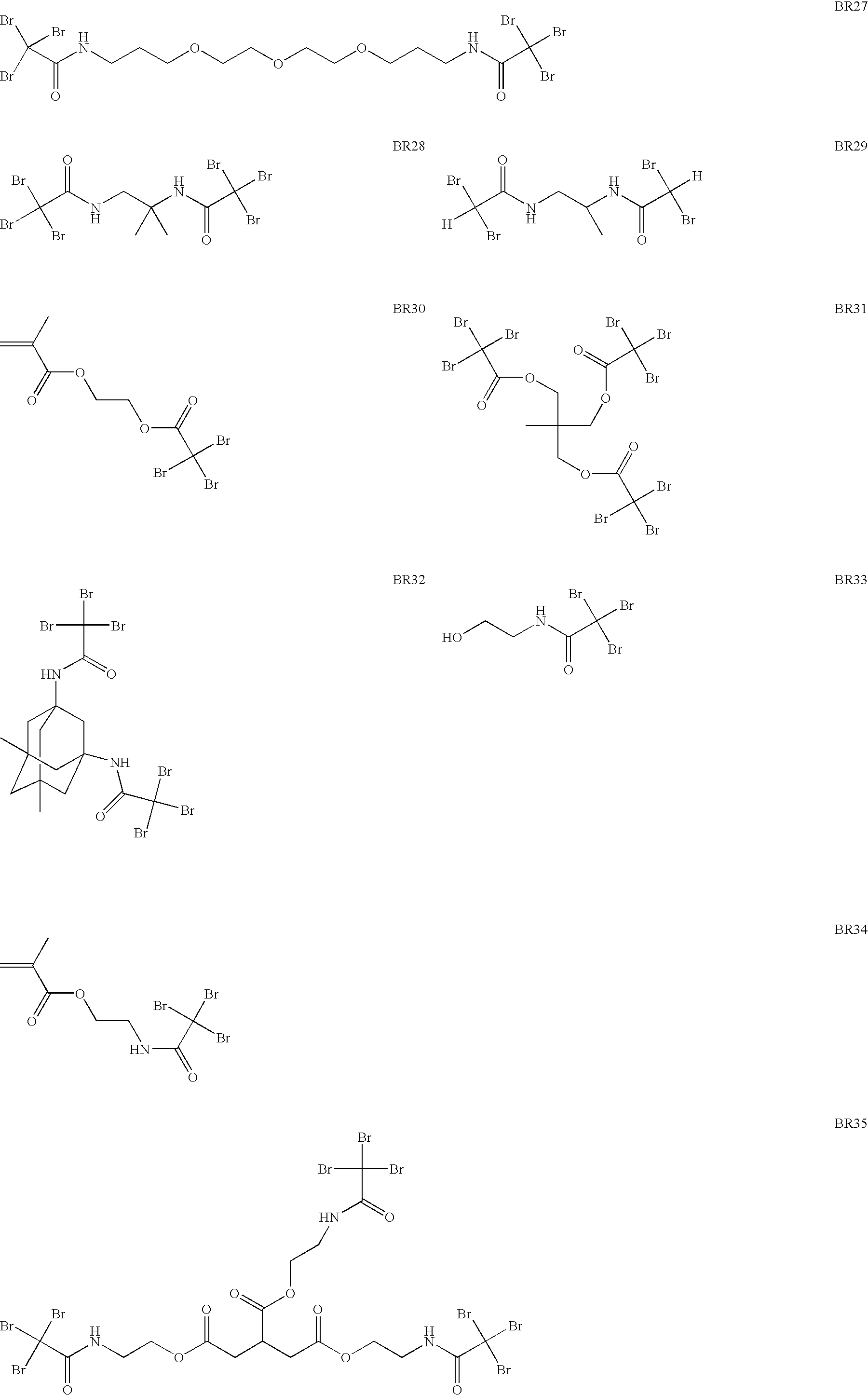

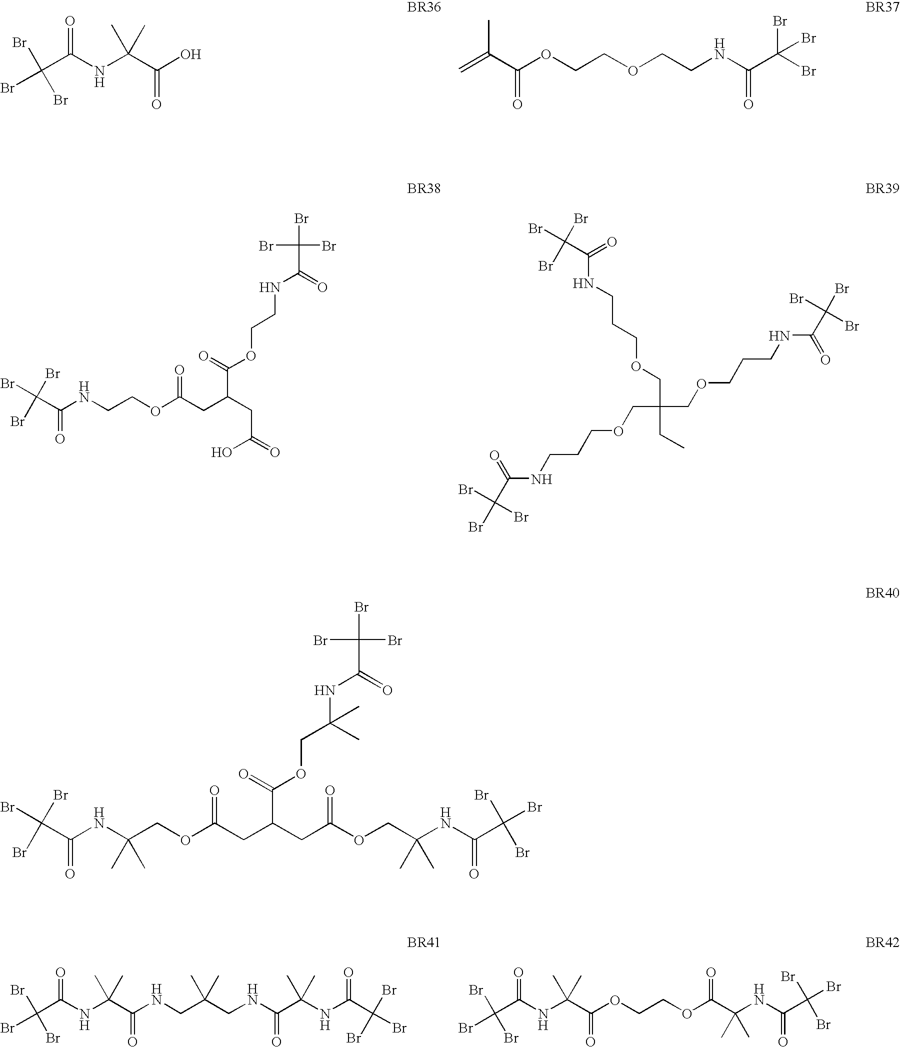

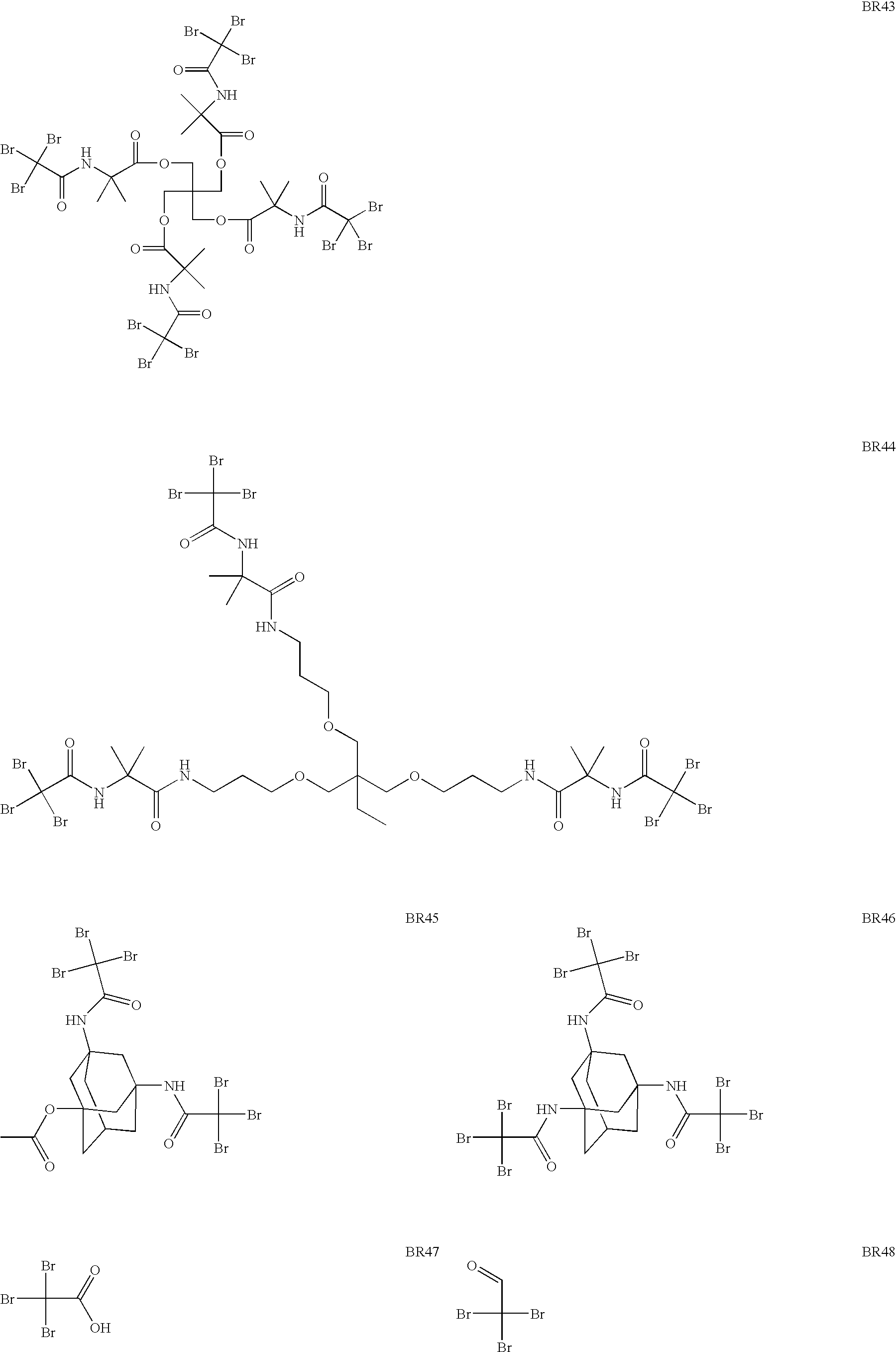

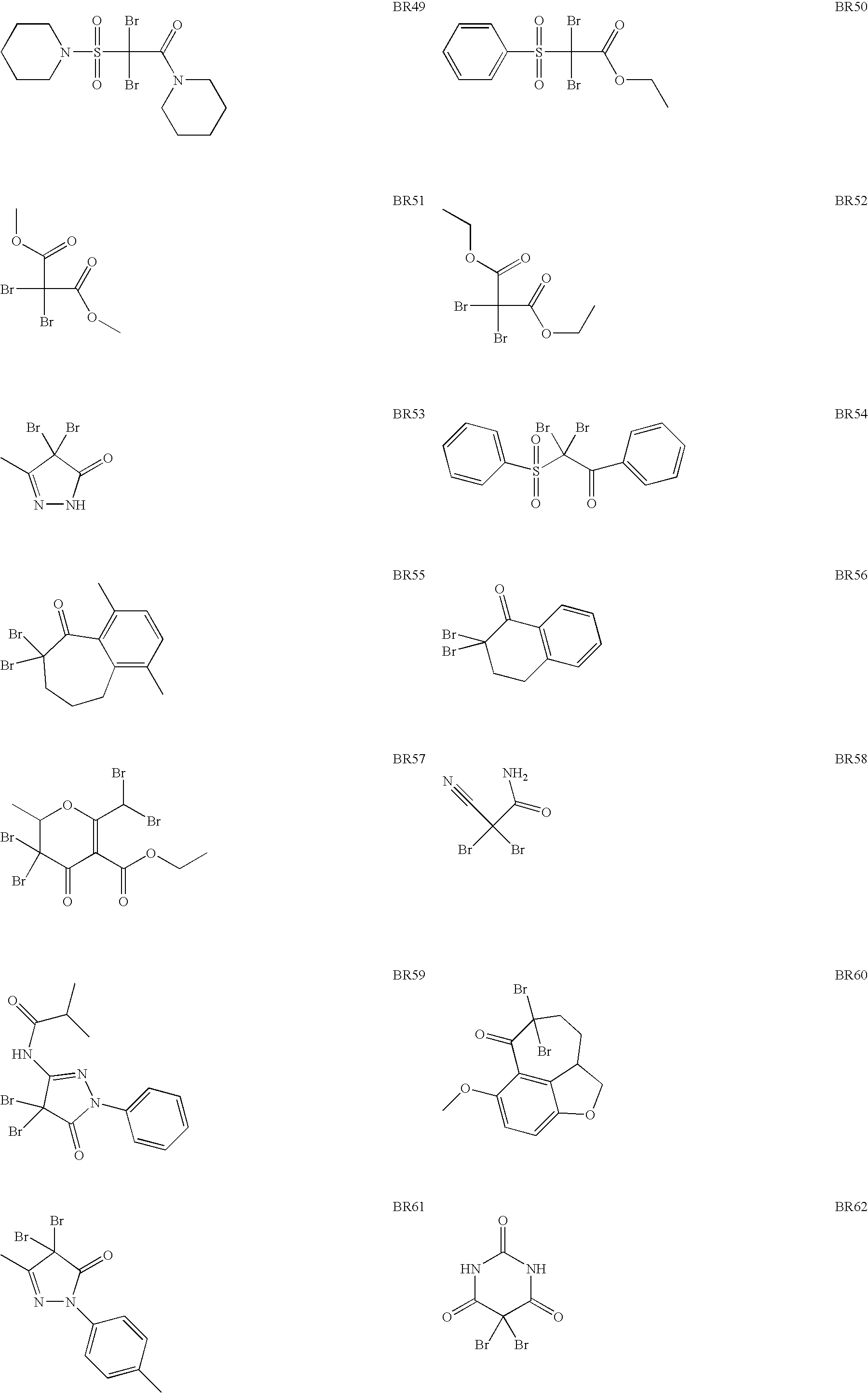

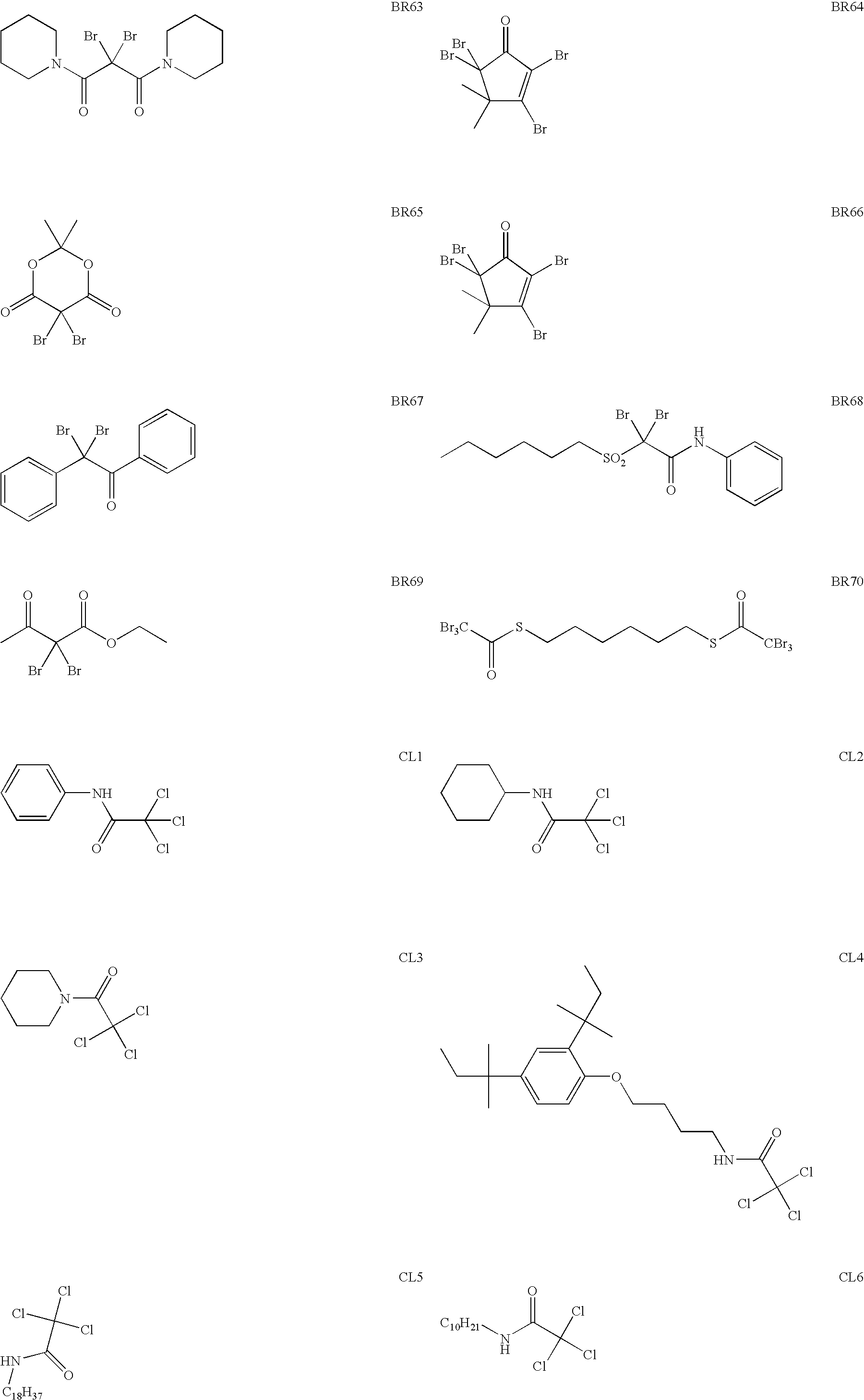

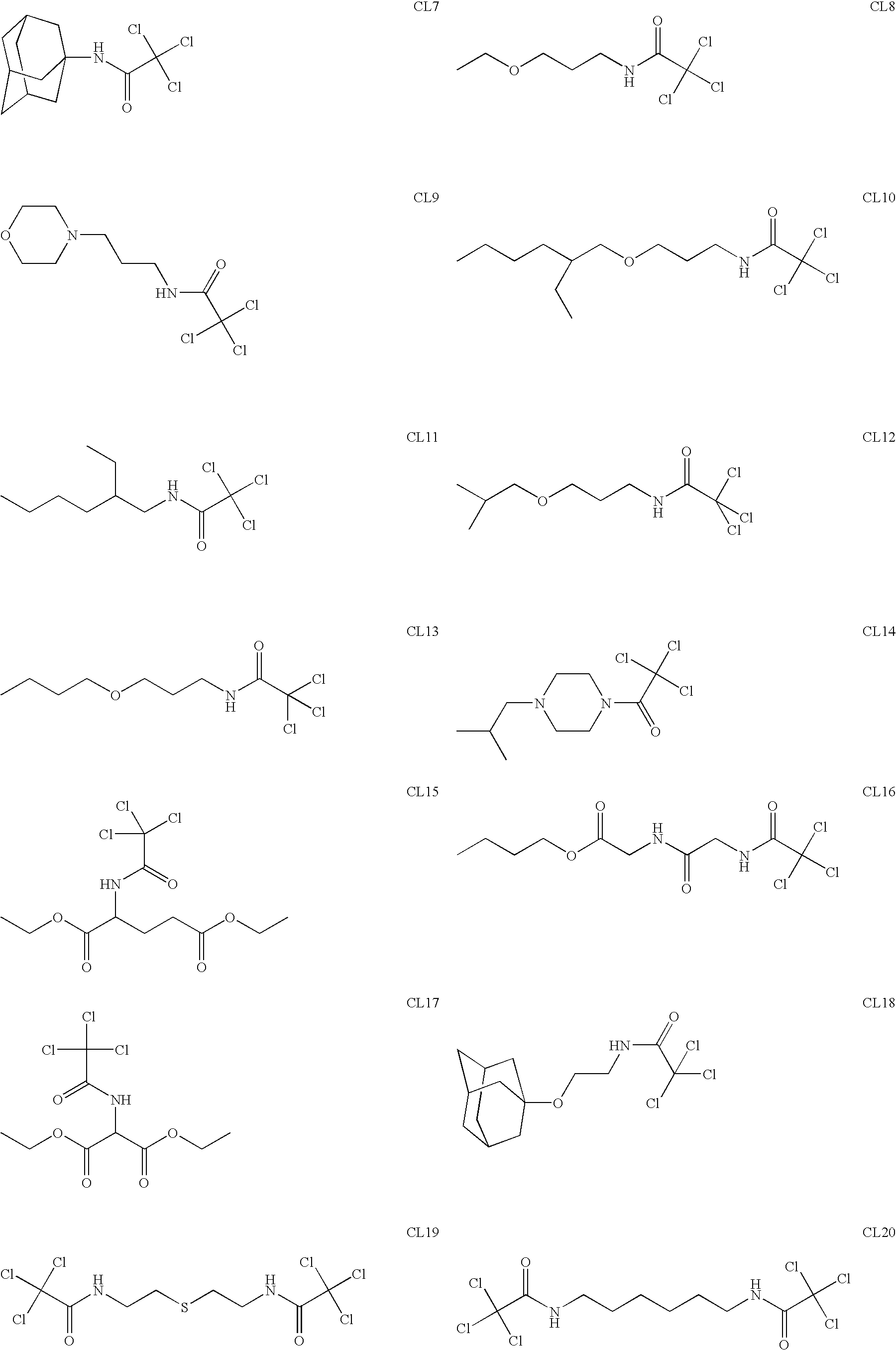

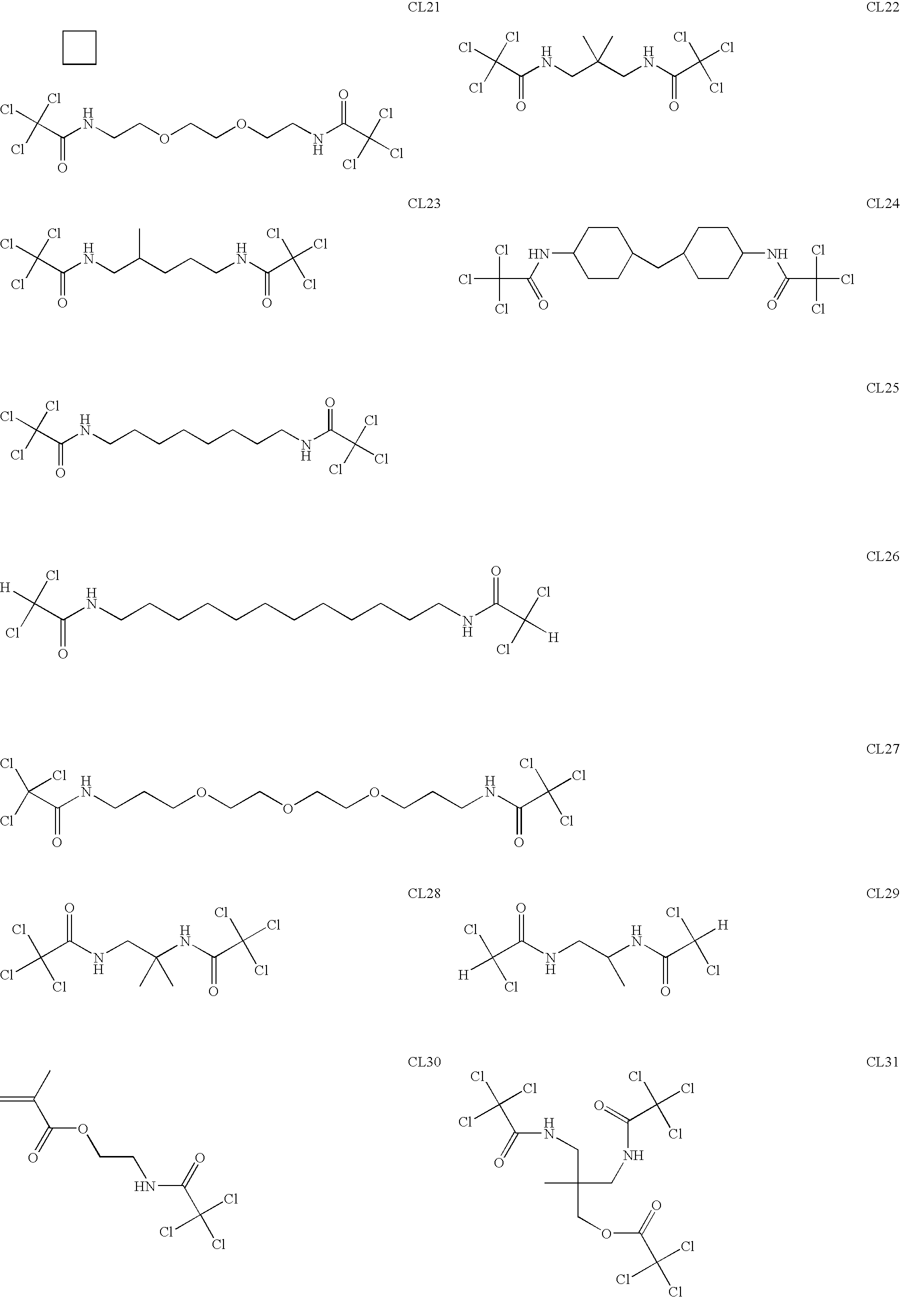

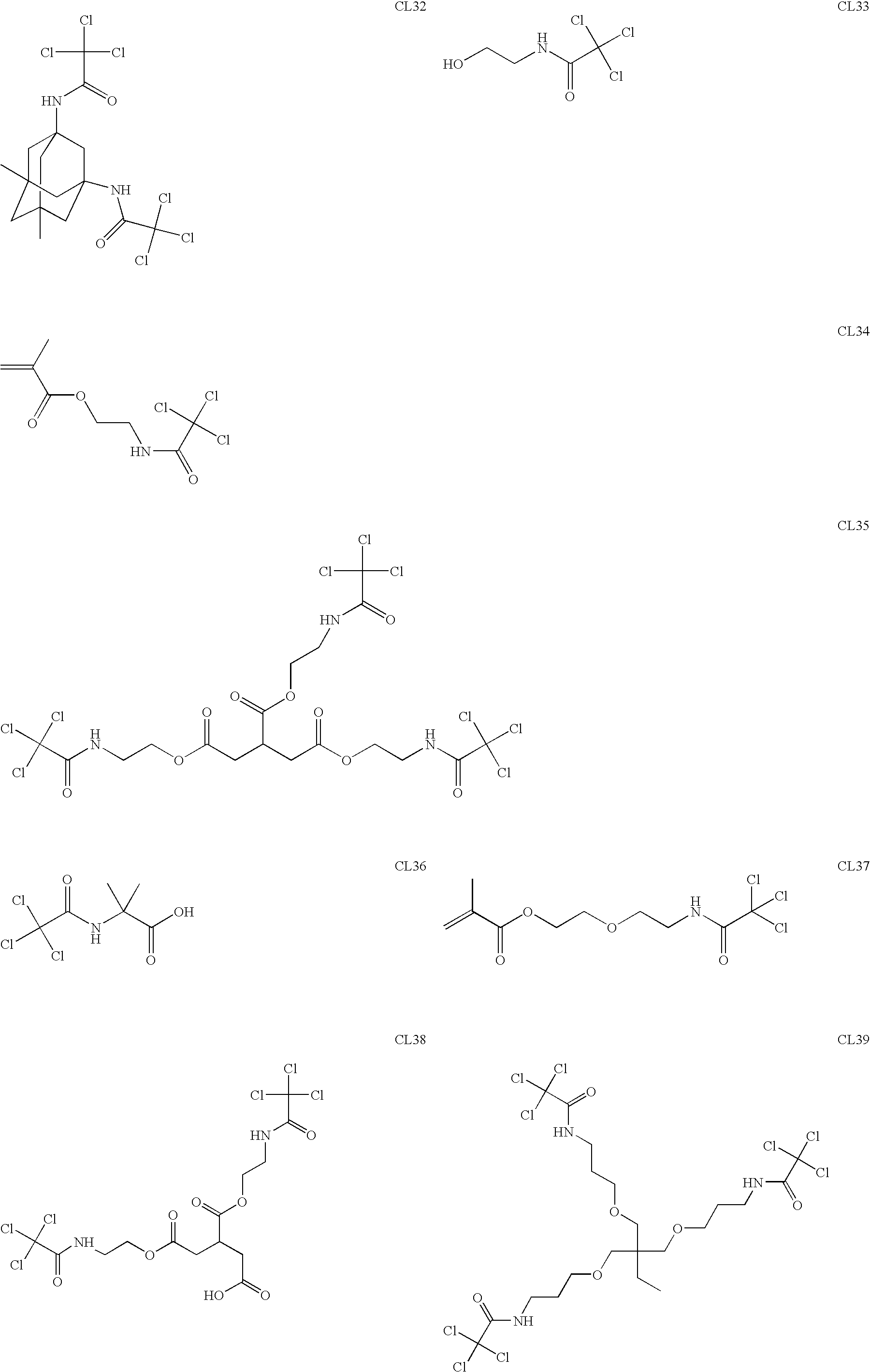

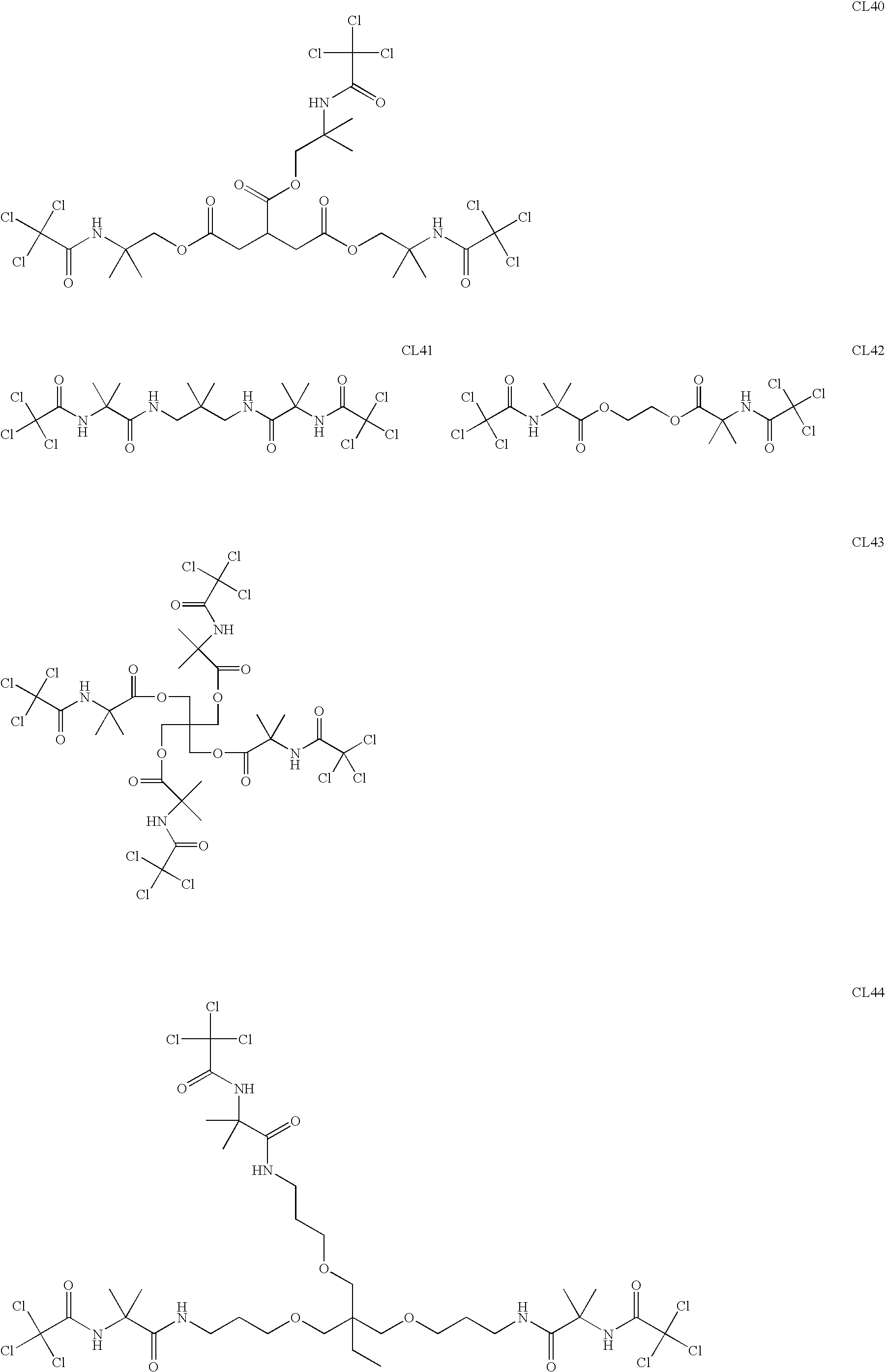

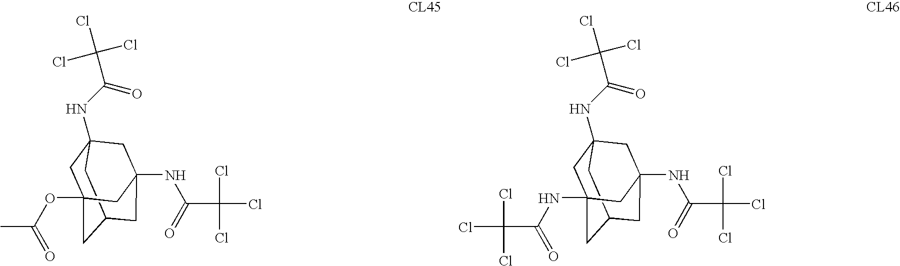

The content of an acid generating agent of formula (7) is preferably from 0.1 to 30% by mass of total solids of the composition of the light-sensitive layer in terms of development latitude and safelight suitability, and more preferably from 1 to 15% by mass.

In cases where the light-sensitive layer is comprised of two layers, an acid generating agent of formula (7) is incorporated preferably to the lower layer in terms of sensitivity and development latitude.

A sulfonium compound represented by formula (8), which results in enhanced abrasion resistance, is also usable in the invention.

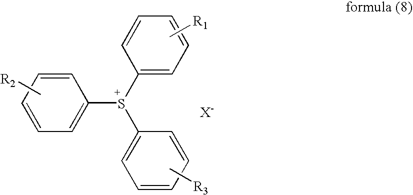

### This compound, which results in enhanced solution resistance of the light-sensitive layer, is contained preferably in the upper layer of the light-sensitive layer.

In formula (8), R₁, R₂ and R₃ are each a hydrogen atom or a substituent, provided that all of R₁, R₂ and R₃ are not hydrogen atoms.

Preferred examples of a substituent of R₁, R₂ and R₃ include an alkyl group such as methyl, ethyl, propyl, isopropyl, butyl, isobutyl, t-butyl, pentyl and hexyl; an alkoxy group such as acetoxy, ethoxy, propoxy, butoxy, hexyloxy, decyloxy and dodecyloxy; a carbonyl group such as acetoxy, propionyloxy, decylcarbonyloxy, dodecylcarbonyloxy, methoxycarbonyl, ethoxycarbonyl and benzoyloxy; a phenylthio group; a halogen atom such as fluorine, chlorine, bromine and iodine; a cyano group:, a nitro group and a hydroxy group.

X represents a non-nucleophilic anionic residue and examples thereof include a halogen atom such as F, Cl, Br and I, B(C₆F₅)₄, R₁₄COO, R₁₅SO₃, SbF₆, AsF₆, PF₆ and BF₄, in which R₁₄ and R₁₅ are each an alkyl or phenyl group which may be substituted by an alkyl group such as methyl, ethyl, propyl and butyl, a halogen atom such as fluorine, chlorine, bromine or iodine, a nitro group, a cyano group or an alkoxy group such as methoxy and ethoxy. Of these, B(C₆F₅)₄ and PF₆ is preferred in terms of safety.

Specific examples of a sulfonium compound of formula (8) are shown below but are by no means limited to these.

| | | | | S—C Bond | |
|---|---|---|---|---|---|
| Compound | | | | Distance | |
| No. | R₁ | R₂ | R₃ | (nm) | X⁻ |
| 1 | —OCH₃ | —OCH₃ | —CF₃ | 0.1695 | B(C₆F₅)₄⁻, SbF₆⁻, PF₆⁻ |
| 2 | —OCH₃ | —OCH₃ | —COF₃ | 0.1696 | B(C₆F₅)₄⁻, SbF₆⁻, PF₆⁻ |
| 3 | —CH═CH₂ | —CH═CH₂ | —COF₃ | 0.1696 | B(C₆F₅)₄⁻, SbF₆⁻, PF₆⁻ |
| 4 | —OCH₃ | —CF₃ | —CF₃ | 0.1692 | B(C₆F₅)₄⁻, SbF₆⁻, PF₆⁻ |
| 5 | —CF₃ | —CF₃ | —CF₃ | 0.1688 | B(C₆F₅)₄⁻, SbF₆⁻, PF₆⁻ |
| 6 | -t-C₄H₉ | -t-C₄H₉ | —CF₃ | 0.1695 | B(C₆F₅)₄⁻, SbF₆⁻, PF₆⁻ |
| 7 | -i-C₃H₇ | -i-C₃H₇ | —CF₃ | 0.1695 | B(C₆F₅)₄⁻, SbF₆⁻, PF₆⁻ |

The content of an acid generating agent of formula (8) is preferably from 0.1 to 30% by mass of total solids of the composition of the light-sensitive layer, and more preferably from 1 to 15% by mass in terms of development latitude and abrasion resistance. Acid generating agents may be used singly or in combination. Acid generating agents may be used in the upper light-sensitive layer within the range not deteriorating safelight suitability.

### Visualizing Agent:

The upper and lower layers preferably contain a colorant as a visualizing agent. As a colorant are cited oil-soluble dyes and basic dyes, inclusive of salt-forming organic dyes. Specifically, a dye which is capable of varying color tone upon reaction with a free radical or an acid is preferred. The expression, varying color tone includes a change in color tone from achroma to chroma, from chroma to achroma and from one color to another color. A preferred dye is one which varies color tone upon reaction with an acid to form a salt.

Examples of an alterant which varies color tone from chroma to achroma or from a color to another one include triphenyl methane dyes, diphenylmethane dyes, oxazine dyes, xanthene dyes, iminonaphthoquinone dyes, azomethine dyes and anthraquinone dyes, such as Victoria Pure Blue BOH (produced by Hodogaya Kagaku Co., Ltd.), Oil Blue #603 (Orient Kagaku Co., Ltd.), Patent Pure Blue (Sumitomo Mikuni Kagaku Co., Ltd.), Crystal Violet, Brilliant Green, Ethyl Violet, Methyl Violet, Methyl Green, Erythrosine B, Basic Fuchsine, Malachite Green, Oil Red, m-Cresol Purple, Rhodamine B, Oramine, 4-p-diethylaminophenyliminonaphthoquinone, and cyano-p-diethylaminophenylacetoanilide.

Examples of an alterant which varied from achroma to chroma include leuco dyes and primary or secondary arylamine dyes such triphenylamine, diphenylamine, o-chloroaniline, 1,2,3-triphenylguanidine, naphthylamine, diaminodiphenylmethane, p,p′-bis-dimethylaminodiphenylamine, 1,2-dianilinoethylene, p,p′,p″-tris-dimethylaminotriphenylmethane, p,p′-bis-dimethylaminodiphenylmethylimine, p,p′,p″-triamino-o-methyltriphenylmethane, p,p′-bis-dimethylaminodiphenyl-4-anilinonaphthylmethane and p,p′,p″-triaminotriphenylmethane.

These dyes may be used singly or in combination. Of these dyes are specifically preferred Victoria Pure Blue BOH and Oil Blue #603

A colorant used in the upper layer is preferably one which exhibits an absorption maximum at a wavelength of less than 800 nm, specifically less than 600 nm. When an acid generating agent is contained in the lower layer, the colorant of the upper layer reduces transmission of visible light, resulting in enhance safelight suitability. In that ca, even an acid generating agent which is not favorable in safelight suitability is also usable.

These dyes are incorporated to a printing plate material preferably in an amount of from 0.01 to 10%, and more preferably from 0.1 to 3% by mass, based total solids of the upper or lower layer.

### Development Inhibitor:

The lower or upper layer may contain various solution inhibitors to control solubility. As a solution inhibitor are suitably used disulfone compounds or sulfone compounds, for example, 4,4′-bishydroxyphenylsulfone. The addition amount is preferably from 0.05 to 20%, and more preferably from 0.5 to 10% by mass of the individual layer.

There may be contained a development inhibitor to enhance solution inhibiting capability. There may be used any development inhibitor which can interact with the alkali-solubleresin, and lowering solubility of an unexposed area in a developer and rendering an exposed are soluble in a developer. Quaternary ammonium salts and polyethylene glycol compounds are preferably used.

Quaternary ammonium salts are not specifically limited but include, for example, a tetraalkylammonium salt, trialkylarylammonium salt, dialkyldiarylammonium salt, alkyltriarylammonium salt, tetraarylammonium salts, cyclic ammonium salts and bicyclic ammonium salts. The addition amount of a quaternary ammonium salt is preferably from 0.1 to 50% by mass, based on total solids of the upper layer and more preferably from 1 to 30% by mass in terms of development inhibition and film forming property.

### Development Accelerator:

The upper and lower layers may contain cyclic acid anhydrides, phenols or organic acids fro enhancement of sensitivity. Specifically incorporation to the lower layer results in enhanced solubility of the light-sensitive layer, leading to no residual film, inhibition of staining and improved cleanness of the shadow portion.

Cyclic acid anhydrides include, for example, phthalic acid anhydrides, tetrahydrophthalic acid anhydride, hexahydrophthalic acid anhydride, 3,6-endooxy-Δ4-tetrahydrophthalic acid, tetrachlorophthalic acid anhydride, maleic acid anhydride, chloromaleic acid anhydride, α-phenylmaleic acid anhydride, succinic acid anhydride, and pyromellitic acid anhydride, as described in U.S. Pat. No. 4,115,128.

Phenols include, for example, bis-phenol A, p-nitrophenol, p-ethoxyphenol, 2,4,4′-trihydrobenzophenone, 2,3,4-trihydroxybenzophenone, 4-hydroxybenzophenone, 4,4′,4″-trihydroxytriphenylmethane, and 4,4′,3″,4″-tetrahydroxy-3,5,3′,5′-tetramethyltriphenylmethane.

Organic acids include, for example, sulfonic acids, sulfinic acids, alkylsulfuric acids, phosphonic acids, phosphoric acid esters and carboxylic acids, as described in JP-A Nos. 60-8942 and 2-96755. Specific examples thereof include p-toluenesulfonic acid, dodecylbenzenesulfonic acid, naphthalenesulfonic acid, p-toluenesulfinic acid, ethyl sulfate, phenylphosphonic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid and ascorbic acid. The foregoing cyclic acid anhydrides, phenols or organic acids are contained preferably in amount of 0.05 to 20% by mass of the composition, more preferably from 0.1 to 15% by mass, and still more preferably from 0.1 to 10% by mass.

There may also be usable an alcoholic compound substituted by a trifluoromethyl group at the α-position, as described in JP-A No. 2005-99298. An electron-withdrawing effect of the trifluoromethyl group of this compound results in enhanced acidity of a hydroxy group at the α-position, leading to enhanced solubility in alkaline developer solution.

### Surfactant:

To achieve enhanced coatability and development stability, the upper and lower layers may be incorporated with nonionic surfactants, as described in JP-A Nos. 62-251740 and 3-208514; amphoteric surfactant, as described in JP-A Nos. 59-121044 and 4-13149; siloxane compounds, as described in EP No. 950517; and fluorine-containing copolymers, as described in 62-170950, 11-288093 and 2001-247351.

Specific examples of nonionic surfactants include sorbitan tristearate, sorbitan monopalmitate, sorbitan trioleate, tearic acid monoglyceride and polyoxyethylene nonylpheny ether. Specific examples of amphoteric surfactants include alkyl-di-(aminoethyl)glycine, hydrochloric acid salt, 2-alkyl-N-carboxyethyl-N-hydroxyethylimidazolinium betaine and N-tetradecyl-N,N-betaine type (trade name AMOGEN K, produced by Daiichi Kogyo Co., Ltd.).

Siloxane compounds are preferably a copolymer of dimethylsiloxane and a polyalkylene oxide. Specific examples thereof include polyalkylene oxide-modified block copolymers, such as DBE-224, DBE-621, DBE-712, DBP-732 (produced by Chisso Co., Ltd.) and Tego Glide 100 (produced by Tego Co.).

The foregoing nonionic surfactant or amphoteric surfactant is incorporated preferably in an amount of from 0.01 to 15%, more preferably from 0.1 to 5%, and still more preferably from 0.05 to 0.5% by mass, based on total solids of the lower or upper layer.

### Aluminum Support:

A variety of materials such as metals and resins are usable as a support.

An aluminum support usable in the invention is a pure aluminum plate or an aluminum alloy plate. A variety of aluminum alloys are usable, for example, alloys of aluminum and metals such as silicon, copper, manganese, magnesium, chromium, nickel, titanium, sodium and iron, and aluminum plated manufactured by various rolling methods are usable. Recently, there are also usable recycled aluminum plates which are manufactured by rolling recycled aluminum metal such as scrap materials and recycled materials.

It is preferred that prior to surface-roughening (graining treatment), the support is subjected to a degreasing treatment to remove roll oil from the surface. There can be employed a degreasing treatment using a solvent such as trichlene or a thinner, and also a degreasing treatment using emulsion of kelosine or triethanol. Aqueous alkali solution, e.g., aqueous caustic soda may be used for the degreasing treatment. Stains or oxide film which cannot be removed only by the degreasing treatment described above can be removed by using such aqueous alkali solution, e.g., aqueous caustic soda. The use of an aqueous alkali solution, such as aqueous caustic soda results in formation of smuts on the surface of the support so that the treated support is preferably subjected to a de-smutting treatment by immersion into an acid such as phosphoric acid, nitric acid, sulfuric acid or chromic acid, or their mixtures.

Subsequently, surface roughening is conducted. Surface roughening can be conducted, for example, by a mechanical method or an electrolytic etching method. In the invention, an ac electrolytic roughening treatment in an electrolyte is preferred but prior thereto, there may be conducted a mechanical surface-roughening treatment or an electrolytic surface roughening treatment mainly using nitric acid.

The mechanical surface roughening usable in this invention is not specifically limited and brush rubbing or honing polishing is preferred. Surface roughening by the brush rubbing can be carried out in such a manner that a rotary brush using brush bristles of 0.2 to 0.8 mm in diameter is rotated, while pressing the brush against the surface of the support and supplying thereto a slurry of 10 to 100 μm diameter particles of volcanic ash, dispersed in water. Honing polishing is carried out in a manner such that 10 to 100 μm diameter particles of volcanic ash are uniformly dispersed in water to form slurry and the slurry is ejected under pressure through nozzle, causing the particles to obliquely collide against the support surface to perform surface roughening. Alternatively, the support surface is laminated with a sheet that is coated with 10 to 100 μm diameter abrasive particles at intervals of 100 to 200 μm and a density of 2.5×10³ to 10×10³ particles/cm² and the roughened pattern of the sheet is transferred under pressure onto the support surface to achieve roughening.

It is preferred that after completion of the mechanical surface roughening, the support is immersed in aqueous acid or alkali solution to remove abrasive particles buried in the surface of the support or aluminum chips formed therein. There are used acids such as sulfuric acid, peroxosulfuric acid, hydrofluoric acid, phosphoric acid, nitric acid and hydrochloric acid, and bases such as sodium hydroxide and potassium hydroxide. Of the foregoing, aqueous alkali solution, such as aqueous sodium hydroxide is preferably used. The dissolution amount of aluminum on the surface is preferably 0.5 to 5 g/m². It is also preferred that after being immersed in an aqueous alkali solution, the support is further immersed in acid such as phosphoric acid, nitric acid, sulfuric acid or chromic acid or a mixture thereof to perform neutralization.

Electrolytic surface roughening using a nitric acid type electrolytic solution is usually carried out by applying a voltage of 1 to 50 volts, and preferably 10 to 30 volts. The electric current density is usually within the range of 10 to 200 A/dm², and preferably 20 to 100 A/dm². The electric quantity is within the range of 100 to 5000 c/dm², and preferably 100 to 2000 c/dm². The surface roughening is carried out at a temperature 10 to 50° C., and preferably 15 to 45° C. The nitric acid concentration of the electrolytic solution is preferably 0.1 to 5% by weight. The electrolytic solution may optionally added with nitrates, chlorides, amines, aldehydes, phosphoric acid, chromic acid, boric acid, acetic acid or oxalic acid.

It is preferred that after completion of the foregoing electrolytic surface roughening using nitric acid, the support is immersed in aqueous acid or alkali solution to remove aluminum chips from the surface of the support. There are used acids such as sulfuric acid, peroxosulfuric acid, hydrofluoric acid, phosphoric acid, nitric acid and hydrochloric acid, and bases such as sodium hydroxide and potassium hydroxide. Of the foregoing, an aqueous alkali solution is preferably used. The dissolution amount of aluminum on the surface is preferably 0.5 to 5 g/m². It is also preferred that after being immersed in an aqueous alkali solution, the support is further immersed in acid such as phosphoric acid, nitric acid, sulfuric acid or chromic acid or a mixture thereof to perform neutralization.

An ac electrolytic surface roughening treatment in an electrolyte mainly composed of hydrochloric acid is conducted at a hydrochloric acid concentration of from 5 to 20 g/l, and preferably from 6 to 15 g/l. The electric current density is usually within the range of 15 to 120 A/dm², and preferably 20 to 90 A/dm². The electric quantity is within the range of 400 to 2000 c/dm², and preferably 500 to 1200 c/dm². The frequency number is preferably from 40 to 150 Hz. The electrolyte temperature is preferably from 10 to 50° C., and more preferably from 15 to 45° C. The electrolytic solution may optionally added with nitrates, chlorides, amines, aldehydes, phosphoric acid, chromic acid, boric acid, acetic acid or oxalic acid.

It is preferred that after completion of the foregoing electrolytic surface roughening using hydrochloric acid, the support is immersed in aqueous acid or alkali solution to remove aluminum chips from the surface of the support. There are used acids such as sulfuric acid, peroxosulfuric acid, hydrofluoric acid, phosphoric acid, nitric acid and hydrochloric acid, and bases such as sodium hydroxide and potassium hydroxide. Of the foregoing, an aqueous alkali solution is preferably used. The dissolution amount of aluminum on the surface is preferably 0.5 to 5 g/m². It is also preferred that after being immersed in an aqueous alkali solution, the support is further immersed in acid such as phosphoric acid, nitric acid, sulfuric acid or chromic acid or a mixture thereof to perform neutralization.

The arithmetic average surface roughness (Ra) on the light-sensitive layer side of the obtained aluminum support is preferably from 0.4 to 0.6 μm, which an be controlled by the combination of a hydrochloric acid concentration, a current density and an electric quantity.

Subsequent to the surface roughening treatment, an anodic oxidation treatment is carried out. The anodic oxidation results in formation of an oxide coat on the surface of the support. There is preferably used an electrolyte of sulfuric acid or mainly composed of sulfuric acid. The sulfuric acid concentration is preferably from 5 to 50% by mass, and more preferably from 10 to 35% by mass. The temperature is preferably from 10 to 50° C. The treatment voltage is preferably not less than 18 V, and more preferably not less than 20 V. The current density is preferably from 1 to 30 A/dm². The electric quantity is preferably from 200 to 6000 C/dm².

The anodic oxidation coverage is preferably from 2 to 6 g/m², and more preferably 3 to 5 g/m². The anodic oxidation coverage can be determined as follows: an aluminum plate is immersed in a chromium phosphoric acid solution (prepared by dissolving 35 ml of a 85% phosphoric acid solution and 20 g of chromium (IV) oxide in 1 L of water) to dissolve the oxidation film and the oxidation coverage is determined from the difference in mass between before and after dissolution of the film. An anodic oxidation film forms micro-pores. The micro-pore density is preferably from 400 to 700 pores/μm² and more preferably from 400 to 600 pores/μm².

A support which has been subjected to the anodic oxidation treatment may optionally be subjected to a sealing treatment of anodic oxide coat. Sealing of the anodic coat can be conducted by commonly known methods, including a hot water treatment, a boiling water treatment, a steam treatment, a sodium silicate treatment, an aqueous bichromate treatment, a nitrite treatment, and an ammonium acetate treatment.

### Hydrophilization Treatment:

After the foregoing treatments, it is preferred to subject the anodic-oxidized support to a hydrophilization treatment in terms of chemical resistance and sensitivity.

The hydrophilization treatment is not specifically limited. The thus treated support may further be sub-coated with water-soluble resin such as polyvinyl phosphonic acid, polyvinyl alcohol or its derivative, carboxymethyl cellulose, dextrin, gum arabic, an amino-containing phosphonic acid such as 2-aminoethylphosphonic acid, a polymer having a side chain containing a sulfonic acid group and its copolymer, poly(acrylic acid), water-soluble metal salts (e.g., zinc borate), yellow dyes and amine salts.

There may also be used a sol-gel treatment substrate, as disclosed in JP-A No. 5-304358. A hydrophilization treatment with an aqueous polyvinylsulfonic acid solution is suitable.

Hydrophilization treatments include, for example, a coating method, a spray method and a dipping method, but the dipping method is suitable. In the dipping method, the treatment is conducted preferably by using an aqueous 0.05-3% polyvinylsulfonic acid solution at a treatment temperature of 20 to 90° C. over a treatment time of 10 to 180 sec. After completing the treatment, it is preferred to perform a squeezing treatment or a washing treatment to remove polyvinylsulfonic acid in excess. It is also preferred to perform a drying treatment preferably at a temperature of 40 to 180° C. (more preferably, 50 to 150° C.). Performing a drying treatment results in enhancements of adhesion to the lower layer, a thermal insulation function, chemical resistance and sensitivity.

The hydrophilized layer thickness is preferably from 0.002 to 0.1 μm, and more preferably from 0.005 to 0.05 μm in terms of adhesion, thermal insulation and sensitivity.

### Back Coat Layer

The printing plate material of the invention may be provided with a back coat layer on the back side of the support to inhibit dissolution of an aluminum anodized film during development. Providing the back coat layer prevents development sludge, whereby replacement of developer is retarded and the replenishing amount of a developer is reduced. Preferred embodiments of a back coat layer include (a) a metal oxide obtained by hydrolysis or polycondensation of organic metal compounds or inorganic metal compounds, (b) colloidal silica sol and (c) an organic polymer compound.

Examples of (a) a metal oxide used in the back coat layer include silica (silicon oxide9, titanium oxide, boron oxide, aluminum oxide, zirconium oxide and their composite material. The metal oxide of the back coat layer is obtained by coating, on the back side of the support, a so-called sol-gel reaction solution obtained by allowing an organic or inorganic metal compound to be hydrolyzed or poly-condensed with an acid or alkali catalyst. Examples of such an organic or inorganic metal compound include a metal alkoxide, a metal acetylacetonate, a metal acetate, metal oxalate, a metal nitrate, a metal sulfate, a metal carbonate, a metal oxychloride, a metal chloride, and their condensation products obtained by hydrolysis and oligomer formation.

### Coating and Drying:

The upper and lower layers of the printing plate material of the invention can be formed by dissolving the individual components described above in solvents and coating them on the support. Solvents as shown below are usable as a coating solvent. These solvents may be used singly or in combination.

Examples of solvents include n-propanol, isopropanol, n-butanol, sec-butanol, isobutanol, 2-methyl-1-butanol, 3-methyl-1̂butanol, 2-methyl-2-butanol, 2-ethyl-1-butanol, 1-pentanol, 2-pentanol, 3-pentanol, n-hexanol, 2-hexanol, cyclohexanol, methylcyclohexanol, 1-heptanol, 2-heptanol, 3-heptanol, 1-octanol, 4-methyl-2-pentanol, 2-hexylalcohol, benzyl alcohol ethylene glycol, diethylene glycol, triethylene glycol, tetraethylene glycol, 1,3-propanediol, 1,5-pentane glycol, dimetyltriglycol, furfuryl alcohol, hexylene glycol, hexyl ether, 3-methoxy-1-butanol, 3-methoxy-3-methylbutanol, butyl phenyl ether, ethylene glycol monoacetate, propylene glycol monomethyl ether, propylene glycol monoethyl ether, propylene glycol monopropyl ether, propylene glycol monobutyl ether, propylene glycol phenyl ether, dipropylene glycol monomethyl ether, dipropylene glycol monoethyl ether, dipropylene glycol monopropyl ether, dipropylene glycol monobutyl ether, tripropylene glycol monomethyl ether, methycarbitol, ethylcarbitol, butylcarbitol, triethylene glycol monomethyl ether, triethylene glycol trimethyl ether, tetraethylene glycol dimethyl ether, diacetone alcohol, acetophenone, cyclohexanone, methlcyclohexanone, acetonylacetone, isophorone, methyl lactate, ethyl lactate, butyl lactate, propylene carbonate, phenyl acetate, sec-butyl acetate, cyclohexyl acetate, diethyl oxalate, methyl benzoate, ethyl benzoate, γ-butylacetone, 3-methoxy-1-butanol, 4-methoxyl-butanol, 3-ethoxy-1-butanol, 3-methoxy-3-methyl-1-butanol, 3-methoxy-3-ethyl-1-pentanol, 4-ethoxy-1-pentanol, 5-methoxy-1-hexanol, 3-hydroxy-2-butanone, 4-hydroxy-2-butanone, 4-hydroxy2-pentanone, 5-hydroxy2-pentanone, 4-hydroxy-3-pentanone, 6-hydroxy-2-pentanone, 4-hydroxy-3-pentanone, 6-hydroxy-2-hexanone, 3-methyl-3-hydroxy-2-pentanone, methyl cellosolve (MC) and ethyl solve (EC).

It is preferred to choose solvents differing in dissolution capability for an alkali-soluble resin of the upper layer and for that of the lower layer. When coating a thermo-sensitive layer as the upper layer on the coated lower layer, the use of a solvent for the upper layer which is capable of dissolving causes nonnegligible mixing near the interface of the layers and in extreme cases, the double layers become a single layer. In cases when two adjacent layers are mixed and dissolved near the interface thereof and behaves as a single layer, targeted effects of the two layers are concerned to be vitiated. Accordingly, an effective solvent used for the upper layer is desirably to be a poor solvent for the alkali-soluble resin of the lower layer.

To inhibit mixing at the interface of the upper and lower layers can be employed a technique of blowing high-pressure air from a nozzle provided in the direction vertical to the running direction of a web, a technique of providing heat to the back side of the web by a roll having a heating medium supplied inside thereof (for example, a heating roll) and combinations thereof.

As a technique to allow two layers to be partially compatible between the layers at a level of each of the two layer achieving their respective targeted effects are cited a method employing difference in solubility in a solvent and a method in which after coating the second layer, a solvent is dried extremely fast, and in each of these methods, the extent thereof can be controlled.

When coating an individual layer, the content of the above-described components (total solids including additives) in solvents is preferably from 1 to 50% by mass. After completion of coating and drying, the coating amount (solids) of the light-sensitive layer on the support is preferably from 0.05 to 1.0 g/m² and that of the lower layer is preferably from 0.3 to 3.0 g/m². The total of the upper and lower layers is preferably from 0.5 to 3.0 g/m² in terms of film property and sensitivity.

The thus prepared coating composition (coating solution for the image forming layer) is coated onto the support by conventional methods and dried to obtain a photopolymerizable light-sensitive lithographic printing plate material. Example of a coating method for a coating solution include, for example, a air-doctor blade coating method, a blade coating method, a wire-bar coating method, a knife coating method, a dip coating method, a reverse roll coating method, a gravure coating method, a cast coating method, a curtain coating method and a an extrusion coating method.

The drying temperature of the light-sensitive layer is preferably from 60 to 160° C., more preferably from 80 to 140° C., and still more preferably from 90 to 120° C. The drying apparatus may be provided with an infrared radiation device to achieve enhanced drying efficiency.

After coating and drying, the light-sensitive layer on the support may be subjected to an aging treatment to stabilize performance. The aging treatment may be conducted continuously, after or separatedly from the drying zone. The aging treatment may be performed as a step for bringing the upper layer surface into contact with a compound containing an OH group, as described in JP-A No. 2005-17599. In the aging step, allowing a polar group-containing compound such as water to permeate or diffuse not only results in enhanced interaction through water in the light-sensitive layer but also can achieve enhanced aggregation strength due to heating, leading to improvement of characteristics of the light-sensitive layer.

The temperature condition is desirably set so that the compound to be diffused is evaporated at a given amount or more. Permeable or diffusible material is typically water but compounds which contain, in the molecule, a polar group such as a hydroxy group, a carboxy group, a ketone group, an aldehyde group, an ester group or the like, are also suitable. The boiling point of such a compound is preferably not more than 200° C., more preferably not more than 150° C., and preferably not less than 50° C., more preferably not less than 70° C. The molecular weight is preferably not more than 150, and more preferably not more than 100.

### Exposure and Development

The thus prepared lithographic printing plate material, which is imagewise exposed and developed in a conventional manner, is used as a printing plate.

A light source exhibiting emission in the wavelength region of near-infrared to infrared is preferable as a light source used for imagewise exposure. A solid laser or a semiconductor laser is specifically preferred. Using a commercially available setter for CTP, imagewise exposure is conducted by an infrared laser (830 nm) based on digitized data, followed by development to form an image on the aluminum plate support, providing a lithographic printing plate.

As an exposure device used for printing plate making is usable any laser beam system, including, for example, an outer drum scanning system, an inner-drum scanning system and a flat-bed scanning system. To enhance productivity at low intensity and long time exposure, an outer-drum system in which a multi-beam system is easily adopted is preferred, and an exposure device of an outer drum system provided with a LV modulation device is specifically preferred.

Multichanneling by using a laser exposure device provided with a GLV modulation device is preferred to enhance productivity in the exposure step of a lithographic printing plate. A GLV modulation device capable separating a laser beam to at least 200 channels is preferred and one capable of separating a laser beam into at least 500 channels is more preferred. The laser beam diameter is preferably not more than 15 μm, and more preferably not more than 10 μm. The laser output is preferably from 10 to 100 W, and more preferably from 20 to 80 W. The rotation speed of a drum is preferably from 20 to 300 rpm, and more preferably from 30 to 200 rpm.

A developer and replenisher applicable to the printing plate material of the invention exhibits a pH of 9.0 to 14.0, and preferably 12.0 to 13.5.

A developer (hereinafter, inclusive of a replenisher) uses an aqueous alkaline solution. For example, sodium hydroxide, ammonium hydroxide and potassium hydroxide are suitably usable as a base. These alkaline chemicals may be used singly or in combination. Alkaline chemicals further include, for example, potassium silicate, sodium silicate, lithium silicate, ammonium silicate, potassium metasilicate, sodium metasilicate, lithium metasilicate, ammonium metasilicate, tripotassium phosphate, trisodium phosphate, trilithium phosphate, triammonium phosphate, dipotassium phosphate, disodium phosphate, dilithium phosphate, diammonium phosphate, potassium carbonate, sodium carbonate, lithium carbonate, ammonium carbonate, potassium hydrogencarbonate, sodium hydrogencarbonate, lithium hydrogencarbonate, ammonium hydrogencarbonate, potassium borate, sodium borate, lithium borate and ammonium borate, and these may be added in the form of a previously formed salt. In that case, sodium hydroxide, ammonium hydroxide, potassium hydroxide or lithium hydroxide may be used for pH adjustment. In combination with the foregoing alkaline chemicals may be used organic alkaline chemicals such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine and pyridine. Of these, potassium silicate and sodium silicate are preferred. The silicate concentration is preferably from 2 to 4% by mass, based on SiO₂. The molar ratio of SIO₂ to alkali metal M (SiO₂/M) is preferably in the range from 0.25 to 2.

The developers referred to in the invention include not only a fresh one used at the start of development but also a so-called running solution in which the replenisher is replenished to correct activity lowered during processing of the lithographic printing plate material.

A developer or a replenisher may optionally be incorporated with various surfactants or organic solvents for the purpose of development acceleration, dispersion of development scum and enhancement of ink affinity in imaging areas of the printing plate.

A developer or a replenisher may further be incorporated with additives to enhance developability, and examples of such additives include neutral salts such as NaCl, KCl and KBr, as described in JP-A No. 58-75152; complexes such as [Co(NH₃)]₆Cl₃, as described in JP-A No. 59-121336; amphoteric polymer electrolytes such as a copolymer of vinylbenzyltrimethyltrimethylammonium chloride and sodium acrylate, as described in JP-A No. 56-142258; organometallic surfactants containing Si, Ti or the like, as described in JP-A No. 59-75255; and organic boron compounds, as described in JP-A No. 59-84241.

A developer and a replenisher may optionally be incorporated with an antiseptic, a colorant, a thickener, a defoaming agent and a water-softening agent.

A concentrated developer or replenisher is advantageous in transportation, which is diluted with water at the time of usage. The degree of concentration is optimized to prevent separation or precipitation of constituents. There may optionally be added a solubilizing agent. Toluenesulfonic acid, xylenesulfonic acid and their alkali salts, so-called hydrotropic agents, as described in JP-A No. 6-32081 are preferably used as a solubilizing agent.

### Non-Silicate Developer

A so-called non-silicate developer which contains no alkali silicate but contains a non-reducing sugar and a base is usable for development of lithographic printing plate materials. Processing of lithographic printing plate material by using this developer does not deteriorate the recording layer surface and can maintain superior ink affinity of the recording layer. In general, lithographic printing plate materials are narrow in development latitude and large in change of line width based on the a pH value of the developer. A non-silicate developer which contains a non-reducing sugar having buffering capability to suppress pH variation is advantageous as compared to a silicate-containing developer. A non-reducing sugar controls developer activity, as compared to a silicate, causing no staining in a conductivity sensor or a pH sensor. In view of the foregoing, a non-silicate developer is advantageous and also results in enhanced discrimination capability.

The foregoing non-reducing sugars, which contains no free aldehyde or ketone group and is a non-reducing saccharide, are classified to a trehalose oligosaccharide in which reducing groups are linked, a glycoside in which a reducing group of a saccharide and a nonsaccharide is linked and a sugar alcohol obtained by hydrogenation of a saccharide, each of which is usable in the invention. Non-reducing sugars described in JP-A No. 8-305039 are also usable in the invention.

Non-reducing sugars may be used singly or in combination. The content of a non-reducing sugar of the non-silicate developer is preferably from 0.1 to 30% by mass and more preferably from 1 to 20% by mass in terms of promotion of high-concentration and availability.

### Processing Method

Making a printing plate from the lithographic printing plate material of the invention is performed by using an automatic processor.

An automatic processor usable in the invention is provided preferably with a mechanism of automatic replenishment of replenisher to the developing bath, preferably with a mechanism of discharging an excess of a developer, preferably with a mechanism to detect transportation of a plate, preferably with a mechanism to estimate the processing area of the plate, based on detection of plate transportation, preferably with a mechanism to control a replenishing amount of a replenisher and/or water and/or timing of replenishment, based on detection of plate transport and/or estimation of the processed area, preferably with a mechanism to control a developer temperature, preferably with a mechanism to detect a pH and/or conductivity of the developer, and preferably with a mechanism of controlling a replenishing amount and/or replenishment timing of the replenisher and/or water, based on a pH and/or conductivity of the developer.

The automatic processor may be provided with a pre-processing section to immerse the plate material into a pre-processing solution prior to the development step. The preprocessing section is provided preferably with a mechanism to spray a preprocessing solution onto the plate material, preferably with a mechanism of controlling the preprocessing solution at a temperature of 25 to 55° C., and preferably with a mechanism of rubbing the plate surface with a roller-form brush.

The thus processed lithographic printing plate material is further subjected to a post-processing treatment with water, a rinse solution containing a surfactant or the like, a finisher mainly composed of gum arabic or starch derivatives, or a protective gum solution. The post-processing of the printing plate material is conducted by various combinations thereof. For instance, development/water washing/treatment with a surfactant-containing rinse solution and development/water washing/treatment with a finisher are preferable in terms of reduced exhaustion of the rinse solution or the finisher solution.

A treatment by countercurrent flow in multiple stages by using a rinse solution or a finisher solution is also preferred. The post-treatment is conducted by using an automatic processor comprised of a development section and a post-processing section. Post-processing treatment is conducted by spraying through a spray nozzle or by conveying while immersed in a processing bath filled with a processing solution. There is also known a method in which after development, a small amount of washing water is supplied to the plate surface to perform washing and waste liquor is reused as a diluting water of a concentrated developer solution. This automatic processing is conducted, while replenishing a replenisher to each of the processing solutions in accordance with a processing amount and running time. There is also applicable non-reusable system of processing with substantially unused processing solution. The thus processed lithographic printing plate material is mounted onto an offset printing machine to perform printing.

### Burning Treatment

The thus prepared lithographic printing plate may be subjected to a burning treatment to achieve highly enhanced plate life.

Prior to burning, the printing plate is treated preferably with a surface-cleaning solution, as described in JP-A Nos. 61-2518 and 55-28062, and JP-A Nos. 62-31859 and 61-159655.

Such a treatment is conducted by coating the plate with a sponge or absorbent cotton soaked in surface-cleaning solution, by immersing the plate into a bath filled with coordinating solution or by coating with an automatic coater. After coating, making the coating amount uniform with a squeegee or a squeezing roller achieves preferred results.

The coating amount of a coordinating solution is preferably from 0.03 to 0.8 g/m² (dry mass). The printing plate coated with a surface-cleaning solution, which may optionally be dried, is heated at a high temperature in a burning processor (for example, BP-1300, produced by Fuji Photo Film). The heating temperature and time, depending on the kind of components constituting images, is preferably from 180 to 300° C. in the range of 1 to 20 min.

The printing plate which was subjected to a burning treatment may optionally be washed or treated with a gumming solution, but when treated with a surface-cleaning solution containing a water-soluble polymeric compound, the desensitization treatment such as gumming may be omitted.

The thus treated lithographic printing plate is mounted onto a printing machine to perform printing.

### Package/Interleaf

After drying the surface layer of a lithographic printing plate material, the lithographic printing material is stocked, maintained or transported while inserting an interleaving paper sheet between printing plate materials to prevent mechanical impact during storage and minimize undesired impact during transportation. The interleaf can be chosen from various kinds of materials.

Interleaf often chooses low-cost raw material to reduce its material cost and can employ paper of 100% wood pulp, blend paper of wood pulp and synthetic pulp or paper coated with low-density or high-density polyethylene. Specifically, paper which does not use synthetic pulp or polyethylene film is low in material cost so that interleaf can be manufactured at low cost.

Preferred specifications of interleaf include a weight of 30 to g/m², a Bekk smoothness (defined in JIS 8119) of 10 to 100 sec., a moisture content (defined in JIS 8127) of 4 to 8% and a density of 7-9×10⁵ g/m³. The surface which is to be brought into contact with the light-sensitive layer is preferably one which is not laminated with a polymeric material.

### Printing:

Printing is conducted by using conventional lithographic printing machines.

Recently, environment protection has been required in the graphic arts industry. Printing inks containing no volatile petroleum organic compound (VOC) have been developed and the use thereof has prevailed. Environment-responsive printing inks include, for example, soybean oil ink “Naturalis 100” produced by Dainippon Ink Co., Ltd., VOC-zero ink “TK High Echo” produced by Toyo Ink Co., Ltd. and process ink “Soycelvo” produced by Tokyo Ink Co., Ltd.

### EXAMPLES

The invention will be further described with reference to examples but embodiments of the invention are by no means limited to these. The expression, part(s) in examples represents part(s) by mass, unless otherwise noted.

Resins of the invention were synthesized as below.

### Modified Novolac Resin: N-1

Modified novolac resin (N-1), corresponding to a resin having a substituent derived from the compound of general formula (5) was prepared in the following manner. First, 29.8 g of dried N,N-dimethylacetoamide and 5.0 g) 0.035 ml) of 5-aminoisocyanuric acid were placed in a reaction vessel fitted with a drying tube and a thermometer and further thereto, 7.8 g (0.035 mol) of isophorone diisocyanate was dropwise added over 10 min. Thereafter, 0.05 g of dibutyltin dilaurate as a reaction catalyst was added and stirred at 60° C. for 5 days. Meanwhile the reaction, as shown in formula (III) proceeded. The progress of the reaction was followed by high-speed liquid chromatography and after almost no peak of unreacted isophorone diisocyanate was observed, the reaction solution was sealed under dried nitrogen gas.

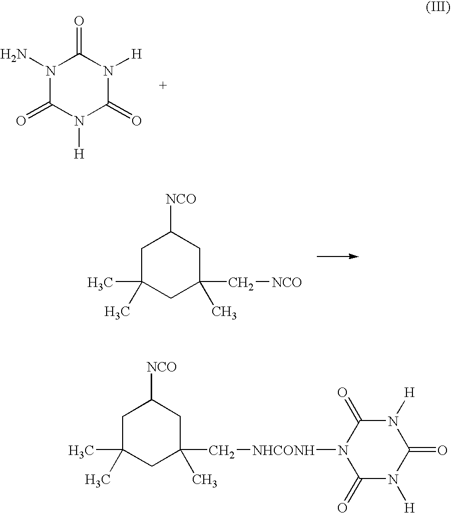

Subsequently, 72 ml of dried N-dimethylacetoamide and 20.0 g of novolac resin shown in Table 1 were placed in a 200 ml reaction vessel and the temperature of the solution was raised to 80° C., while dissolving the novolac resin under an atmosphere of dry nitrogen gas. Further thereto, 5.1 g of the foregoing reaction solution (30 masse solution, isocyanate concentration of 0.0042 mol) was added, dibutyltin dilaurate as a reaction catalyst and the reaction continued at 80° C. until residual isocyanate disappeared. The residual isocyanate was measured in a back titration method by addition of dibutylamine. After disappearance of residual isocyanate was confirmed, the reaction solution was cooled to room temperature and poured to 1 liter of deionized water with stirring to deposit a resin. The deposited resin was filtered off, washed and dried under reduced pressure at 40° C. to obtain 19.3 g of a novolac resin containing a side chain having an isocyanuric acid group, as represented by formula below (in which m and n each represent the number of repeating units). The rate of introduction of an isocyanuric acid group to a hydroxy group of the novolac resin was 2.5 mol %.

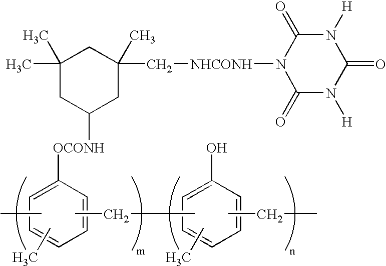

### Modified Novolac Resin: N-2

First, 34 parts of phenol, 60 parts of cresol, 39 parts of hydroxyethyl isocyanurate, 53 parts of 41.5% formalin and 0.19 parts of triethylamine were placed a flask fitted with a stirrer, a reflux condenser with a snap tap and a thermometer and raised to a temperature of 70° C. After reacted for 5 hrs., the reaction solution was raised to a temperature of 120° C. over 2 hrs. under atmospheric pressure. Subsequently, unreacted phenol was removed under reduced pressure to prepare a modified novolac resin: N-2 (exhibiting a softening point of 127° C.), corresponding to a resin having a substituent derived from the compound of general formula (5).

### Modified Novolac Resin: N-3

In tetrahydrofuran (THF) was dissolved 150 parts of a cresol novolac resin (m/p=7/3, molecular weight of 4,000, MEK solution with 70% solid), 30 parts of hydroxyethyl isocyanurate monoacrylate was gradually added thereto with stirring and reacted at room temperature for 24 hrs. to obtain a modified novolac resin: N-3 (exhibiting a softening point of 160° C.), corresponding to a resin having a substituent derived from the compound of general formula (5).

### Modified Novolac Resin: N-4

In tetrahydrofuran (THF) was dissolved 150 parts of a cresol novolac resin (m/p=7/3, molecular weight of 3,000, MEK solution with 70% solid), 30 parts of tris(2-hydroxyethylisicyanurate)triacetate triacrylate was gradually added with stirring and reacted for 24 hrs. at room temperature to obtain a modified novolac resin: N-3 (exhibiting a softening point of 160° C.), corresponding to a resin having a substituent derived from the compound of general formula (5).

### Modified Novolac Resin: N-5

Modified novolac resin (N-5) corresponding to a resin having a substituent derived from the compound of general formula (2) was prepared similarly to the foregoing novolac resin (N-1), except that 5-aminoisocyanuric acid was replaced by 4-aminourazole.

### Modified Novolac Resin: N-6

Modified novolac resin (N-6) corresponding to a resin having a substituent derived from the compound of general formula (1) was prepared similarly to the foregoing novolac resin (N-1), except that 5-aminoisocyanuric acid was replaced by 4-aminoparabanic acid.

### Modified Novolac Resin: N-7

Modified novolac resin (N-7) corresponding to a resin having a substituent derived from the compound of general formula (3) was prepared similarly to the foregoing novolac resin (N-1), except that 5-aminoisocyanuric acid was replaced by 5-aminouracil.

### Modified Acryl Resin: AR-1

First, 42.0 g (0.175 mol) of (p-hydroxyphenyl)-methacrylamide, 14.25 g of methyl methacrylate (MMA: 0.124 mol), 7.95 g of acrylonitrile (AN: 0.15 mol), 13.0 g of ethyl isocyanurate monoacrylate (0.06 mol) and 200 g of N,N-dimethylacetoamide were placed in a three-necked flask fitted with a stirrer, a condenser and a dropping funnel, and the mixture was stirred with heating at 65° C. in a water bath. To the mixture was added 1.5 g of V-65 (produced by Wako Junyaku Co., Ltd.) and stirred for 2 hrs. under nitrogen gas stream, while being maintained at 65° C. To this reaction mixture, the foregoing monomers in the same amount and the same molar ratio were added through a dropping funnel over 2 hrs. and stirred at 65° C. for 2 hrs. After completion of reaction, 150 g of methanol was added and cooled. The obtained mixture was poured to 2 liters of water with stirring and after stirred for 30 min., the formed deposit was filtered off and dried to obtain 135 g of modified acryl resin AR-1 (weight average molecular weight: 50,000, GPC, based on polystyrene) corresponding to a resin having a substituent derived from the compound of formula (5).

### Modified Acryl Resin: AR-2

First, 120 parts of N,N-dimethylacetoamide was placed in a flask fitted with a condenser, a nitrogen-introducing tube, a dropping funnel and a stirrer. Further thereto, 12.72 parts and 17.16 parts of 4-hydroxybenzaldehyde were added and dissolved. While cooling in a water bath, 14.88 parts of triethylamine was dropwise added to this solution over 1 hr. and stirred for 3 hrs. to synthesize a compound (j) (also denoted as AHB, provided that R³═H), shown in the following reaction formula (IV):

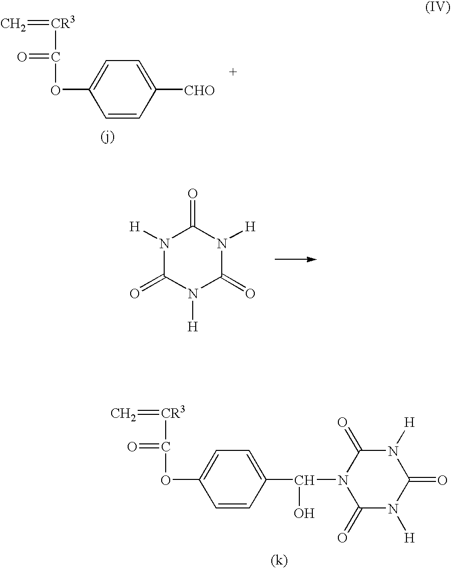

Subsequently, 120 parts of N,N-dimethylacetoamide was placed in another flask and heated at 80° C. with introducing nitrogen gas. Separately, acrylonitrile (AN) and methyl methacrylate (MMA) monomers were added to a solution containing the foregoing compound (j or AHB) at the ratio of AHB:An:MMA=40:30:30 and 3.2 parts of azobisisobutyronitrile was further dissolved therein to make a monomer solution. To the solution heated at 80° C. in the flask, the above-described monomer solution was added over 1 hr. and stirred at 80° C. for 3 hrs to obtain an acryl resin containing a side chain having an aldehyde group. After cooling the solution, 18.0 parts of isocyanuric acid and 10 parts of hot water were added to the solution in the flask and stirred at 60° C. for 2 hrs., while introducing air in place of nitrogen gas into the flask. The solution was poured to water and the formed deposit was recovered by filtration and dried under reduced pressure to obtain an acryl resin having a side chain with an isocyanuric acid group (AR-2), that is, a resin having a substituent derived from the compound of formula (5).

### Modified Acryl Resin: AR-3

Modified acryl resin AR-3 [a resin having a substituent derived from the compound of formula (5)] was prepared similarly to the foregoing acryl resin AR-1, except that ethyl cyanurate monoacrylate was replaced by tris(2-hydroxyethyl)isocyanurate triacrylate monomer.

### Modified Acryl Resin: AR-4

First, 19.00 g of acryloyl chloride and 24.42 g of 4-hydroxybenzaldehyde were added to 100 g of tetrahydrofuran and dissolved with stirring. While cooling the solution in a water bath, 22.22 g of triethylamine was added to the solution over 30 min. and stirred 3 hrs. to synthesize a compound (j), shown in the following reaction formula (IV). Subsequently, 25.62 g of isocyanuric acid and 100 g of hot water were added thereto and stirred at 60° C. for 3 hrs. to obtain a solution. The obtained solution was poured to 1000 ml of water and the formed deposit was recovered by filtration and dried under reduced pressure to obtain 57 g of a compound (k) in which R³═H, shown in the reaction formula (IV), and the compound (k) also being denoted as AHB′.

Into a flask fitted with a condenser, a nitrogen-introducing tube, a thermometer, a dropping funnel and a stirrer was placed 132 parts of N,N-dimethylacetoamide and heated to 80° C. with stirring, while introducing nitrogen gas into the flask. Monomers of 57 g of AHB′, acrylonitrile (AN) and methyl methacrylate (MMA) were mixed at a ratio of AHB′:AN:MMA=40:30:30, and a mixture of the monomers and 2.4 parts of azobisisobutyronitrile were dissolved in 132 parts of N,N-dimethylacetoamide to obtain a monomer solution. The monomer solution was dropwise added to N,N-dimethylacetoamide within the flask over 1 hr. and stirred at 80° C. for 3 hrs. This solution was poured into water and the formed deposit was recovered by filtration and dried under reduced pressure to obtain an acryl resin having a side chain with an isocyanuric acid group (AR-4), that is, an acryl resin having a side chain with a substituent derived from the compound of formula (5).

### Modified Acryl Resin: AR-5

Modified acryl resin AR-4 was prepared similarly to the foregoing AR-4, except that cyanuric acid was replaced by uracil. The resin AR-4 is a resin having a side chain with a substituent derived from the compound of formula (5).

### Modified Acetal Resin: AS-1

First, 110 g of polyvinyl alcohol (Mowiol 3-98, 98% hydrolyzed polyvinyl acetate having an average molecular weight of 16000) was placed in a closed reaction vessel fitted with a water-cooling condenser, a dropping funnel and a thermometer and containing 250 g of deionized water, and heated at 90° C. for 1 hr. until forming transparent solution. Thereafter, the temperature was adjusted to 60° C. and 3 g of concentrated sulfuric acid as added thereto. A solution of 59.8 g of 4-hydroxybenzaldehyde and 1.4 g of 2,6-di-t-butyl-4-methylphenol in 450 g of 2-methoxyethanol was dropwise added to the reaction vessel. The reaction mixture was diluted with 500 g of 2-methoxyethanol and thereto, a mixture of 35.3 g of n-butylaldehyde and 2-hydroxyethyl isocyanurate (1:1) in 500 g of 2-methoxyethanol was dropwise added. After adding all of monomers, the reaction mixture was reacted at 50° C. for 3 hrs. Water was distilled away from the reaction mixture and replaced by 2-methoxyethanol (in which water of less than 3% was remained in the solution). The reaction mixture was neutralized with sodium hydrogencarbonate to a pH of 7±0.5 and then blended with water-methanol (10:1). A deposited polymer was washed with water, filtered and dried by hot air of 50° C. to obtain a modified acetal resin AS-1. The acetal resin AS-1 is a resin having a side chain with a substituent derived from the compound of formula (5).

### Preparation of Substrate

A 0.24 mm thick aluminum plate (material No. 1050, H16) was immersed into an aqueous 5% sodium hydroxide solution maintained at 50° C. for 1 min to conduct a dissolution treatment until reached a solution amount of 2 g/m² and then washed with water, then immersed in an aqueous 10 mass % nitric acid solution for 30 sec to perform neutralization and washed. Subsequently, the aluminum plate was subjected to electrolytic surface roughening in an aqueous solution containing hydrochloric acid of 10 g/L and aluminum of 0.5 g/L using an alternant current under the condition of a current density of 60 A/dm² at 25° C.

Meanwhile, the distance between the electrode and the sample surface was 10 mm. The electrolytic surface roughening treatment was divided 12 times and the electric quantity for each electrolysis (at the anode) was 80 C/dm² and the total electric quantity (at the anode) was 960 C/dm². A stoppage time of 1 sec. was provided between the respective surface-roughening treatments.

After electrolytic surface roughening, the plate was immersed in an aqueous 10 mass % phosphoric acid solution and subjected to an etching treatment until a dissolution amount including smut reached 1.2 g/m² and washed with water.

Subsequently, the plate was subjected to an anodic oxidation treatment at a constant voltage of 20 V and an electric quantity of 250 C/dm² and washed with water. After washing, water on the surface was squeezed and the plate was immersed in an aqueous 2 mass % sodium silicate solution maintained at 85° C. for 30 sec., washed with water, immersed in aqueous 4 mass % polyvinylphosphonic acid solution of 60° C. for 30 sec. and washed with water. The surface was squeezed and promptly subjected to a heating treatment at 130° C. for 50 sec. to obtain a substrate.

The average roughness of the substrate, which was measured by SE 1700α (produced by Kosaka Laboratory Co., Ltd.), was 0.55 m. The cell diameter of the substrate, which was observed by a scanning electron microscope (SEM), was 40 nm. The thickness of polyvinylphosphonic acid was 0.01 μm.

### Preparation of Single-layered Printing Plate Material Coating and Drying:

On the surface-treated support (substrate) described above, a coating composition of an infrared-sensitive layer, as described below-was coated by a three-roll coater so as to have a dry coverage of 1.40 g/m² and dried at 120° C. for 1.0 min.

After cut to a size of 600×400 mm, 200 sheets of the prepared light-sensitive lithographic printing plate material was piled up with inserting an interleaf therebetween. After the light-sensitive layer was dried as such, and aged for 24 hrs. under the condition at a temperature of 50° C. and an absolute humidity of 0.037 kg/kg.

### Interleaf P:

A bleached kraft pulp was beated and diluted to a 4% concentration, then, 0.4 mass % of a rosin sizing agent was added and aluminum sulfate was added so as to reach a pH of 5. To this stuff, 5.0% by weight of a strengthening agent mainly composed of starch was added and subjected to paper-making to prepare interleaf P having a moisture content of 5% and a weight of 40 g/m².

### Infrared-Sensitive Layer Coating Solution

| | |
|---|---|
| Acryl resin 1 | 10 parts |
| Resin (Table 1) | Table 1 |
| Victoria Pure Blue dye | 3.0 parts |
| Acid-decomposable compound (Table 1) | Table 1 |
| Acid generation agent BR 22 | 5.0 parts |
| Infrared absorption dye (Dye 1) | 5.0 parts |
| Fluorinated surfactant; Megafac F-178 | 0.8 parts |
| (produced by Dainippon Ink Co.) | |

Solvent: methyl ethyl ketone/1-methoxy-2-propanol (2/1) to make 1000 parts of the single light-sensitive layer

The foregoing composition was changed to resin, acid-decomposable compound and the kind and content (% solids) of a compound containing a melamine or triazine group, as shown in Table 1 to obtain lithographic printing plate materials.

### Preparation of Double-layered Printing Plate Material Coating and Drying:

On the surface-treated support (substrate) described above, a coating composition of an infrared-sensitive lower layer, as described below was coated by a three-roll coater so as to have a dry coverage of 0.85 g/m² and dried at 120° C. for 1.0 min.

Further thereon, a coating composition of an infrared-sensitive upper layer, as described below was coated by a roll coater so as to have a dry coverage of 0.25 g/m² and dried at 120° C. for 5.0 min. After cut to a size of 600×400 mm, 200 sheets of the prepared light-sensitive lithographic printing plate material was piled up with inserting an interleaf therebetween. After the light-sensitive layer was dried as such, and aged for 24 hrs. under the condition at a temperature of 50° C. and an absolute humidity of 0.037 kg/kg.

### Interleaf P:

A bleached kraft pulp was beated and diluted to a 4% concentration, then, 0.4 mass % of a rosin sizing agent was added and aluminum sulfate was added so as to reach a pH of 5. To this stuff, 5.0% by weight of a strengthening agent mainly composed of starch was added and subjected to paper-making to prepare interleaf P having a moisture content of 5% and a weight of 40 g/m².

### Infrared-Sensitive Lower Layer Coating Solution

| | |
|---|---|
| Lower layer resin (Table 2) | Table 2 |
| Victoria Pure Blue dye | 3.0 parts |
| Acid-decomposable compound (Table 2) | Table 2 |
| Acid generation agent (Table 2) | Table 2 |
| Infrared absorption dye (Dye 1) | 5.0 parts |
| Fluorinated surfactant; Megafac F-178 | 0.8 parts |
| (produced by Dainippon Ink Co.) | |

Solvent: γ-butyrolactone/methyl ethyl ketone/1-methoxy-2-propanol (1/2/1) to make 1000 parts of the lower layer

### Infrared-Sensitive Upper Layer Coating Solution

| | |
|---|---|
| Upper layer resin (Table 3) | Table 3 |
| Acryl resin 1 | 4.0 parts |
| Infrared absorption dye (Dye 1) | 1.5 parts |
| Fluorinated surfactant; Megafac F-178 | 0.5 parts |
| (produced by Dainippon Ink Co.) | |
| Acid generation agent (Table 3) | Table 3 |
| Fluoroalkyl-containing acryl resin | Table 3 |

Solvent: methyl ethyl ketone/1-methoxy-2-propanol (1/2) to make 1000 parts of the upper layer

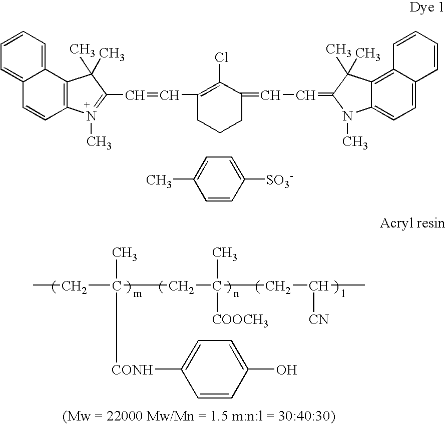

The foregoing composition was changed to a resin, acid-decomposable compound and an acid generating agent of the lower layer, as shown in Table 2 and a resin, an acid-decomposable compound and the kind and content (% solids) of a fluoroalkyl-containing acryl resin of the upper layer, as shown in Table 3, whereby lithographic printing plate materials were obtained.

### Exposure and Development

Each of the obtained lithographic printing plate materials was exposed through a test pattern of a dot image corresponding to 175 lines by using PTR-430 (produced by Dainippon Screen Seizo) at a drum rotation speed of 1000 rpm and a resolution of 2400 dpi with varying the laser output in the range of 30 to 100%.

The exposed printing plate materials were processed using an automatic processor (Raptor 85 Thermal, produced by GLUNZ & JENSEN Co.) and a developer TD-1 (Kodak Polychrome).

### Evaluation Sensitivity:

100% solid image exposure was performed with varying laser exposure energy and the density at each of exposure energies was measured by a densitometer (D196, produced by GRETAG Co.). The sensitivity was defined as an energy (mJ/cm²) necessary to give a density of a density of the support plus 0.01.

### Development Latitude:

The printing plate material samples were exposed through a test pattern of a dot image corresponding to 175 lines by using PTR-430 (produced by Dainippon Screen Seizo) at a drum rotation speed of 1000 rpm and a resolution of 2400 dpi with varying the laser output in the range of 30 to 100%.

Separately, 10,000 sheets of infrared thermal positive printing plate material TP-W (Kodak Polychrome) were continuously processed using a (1:8) developer of TD-1 (Kodak Polychrome) and an automatic processor (Raptor 85, produced by Thermal GLUNZ & JENSEN Co.). Using the developer used in the running process described above, each of the exposed printing plate material samples was developed at 30° C. for a time of 5 to 90 sec, (at a 4 sec. interval).

Developed samples were observed with a magnifier whether there was staining or coloring due to residual layer in non-imaging areas, caused by development trouble and the development time width in which superior development was performed was defined as development latitude.

### Abrasion Resistance:

Using an abrasion resistance tester (HEIDON-18), the surface of the light-sensitive layer was scratched with a 0.5 mm φ sapphire needle, while increasing the load from 1 g to 40 g at an interval of 1 g and then developed with a concentrated developer (1:4) of TD-1 (Kodak Polychrome) to evaluate durability (in terms of weight) of the light-sensitive layer. A higher value indicates superior abrasion resistance.

Test conditions and results are shown in Tables 1-4. It was proved that lithographic printing plate materials of the invention were superior in sensitivity, development latitude and abrasion resistance.

TABLE 1

| | | | | Develop- | |
|---|---|---|---|---|---|
| | | | | ment | Abrasion |
| Sample | Resin | Compound* | Sensitivity | Latitude | Resistance |
| No. | (%) | 1 (part) | (mj/cm²) | (sec) | (g) |
| 1 | CNR (80) | — | 260 | 5 | 1 |
| (Comp.) | | | | | |
| 2 | CNR (80) | A4 (5) | 190 | 15 | 2 |
| (Comp.) | | | | | |
| 3 | CNR/AS-1 | — | 150 | 25 | 3 |
| (Inv.) | (50/30) | | | | |
| 4 | CNR/AR-4 | — | 140 | 30 | 3 |
| (Inv.) | (50/30) | | | | |
| 5 | CNR/AR-2 | — | 130 | 45 | 4 |
| (Inv.) | (50/30) | | | | |
| 6 | CNR/AR-3 | — | 130 | 35 | 4 |
| (Inv.) | (50/30) | | | | |
| 7 | CNR/AR-1 | — | 120 | 50 | 4 |
| (Inv.) | (50/30) | | | | |
| 8 | CNR/AR-5 | — | 150 | 30 | 3 |
| (Inv.) | (50/30) | | | | |
| 9 | CNR/AR-1 | — | 150 | 30 | 3 |
| (Inv.) | (70/10) | | | | |
| 10 | CNR/AR-1 | — | 120 | 55 | 4 |
| (Inv.) | (20/60) | | | | |
| 11 | N-1 (80) | — | 140 | 50 | 3 |
| (Inv.) | | | | | |
| 12 | N-2 (80) | — | 120 | 55 | 4 |
| (Inv.) | | | | | |
| 13 | N-3 (80) | — | 110 | 60 | 4 |
| (Inv.) | | | | | |
| 14 | N-4 (80) | — | 105 | 65 | 4 |
| (Inv.) | | | | | |
| 15 | N-5 (80) | — | 150 | 30 | 3 |
| (Inv.) | | | | | |
| 16 | N-6 (80) | — | 145 | 40 | 3 |
| (Inv.) | | | | | |
| 17 | N-7 (80) | — | 145 | 45 | 3 |
| (Inv.) | | | | | |
| 18 | N-3 (80) | A4 (5) | 100 | 75 | 4 |
| (Inv.) | | | | | |
| 19 | CNR/N-3 | A4 (5) | 120 | 65 | 4 |
| (Inv.) | (60/20) | | | | |
| 20 | N-3/AR-1 | A4 (5) | 95 | 75 | 4 |
| (Inv.) | (50/30) | | | | |

A4: Synthesis Example A4 of acid-decomposable compound of formula (6)
*CNR: Cresol novolac resin (m/p = 6/4, M.W. = 4000)

TABLE 2

| | Lower Layer | | |
|---|---|---|---|
| Sample | | Acid-decomposable | Acid Generator |
| No. | Resin (%) | Compound (part) | (part) |
| 1 (Comp.) | ACR (80) | — | — |
| 2 (Comp.) | ACR (80) | A4 (5) | BR 22 (3) |
| 3 (Comp.) | ACR (80) | — | — |
| 4 (Comp.) | ACR (80) | — | TAZ 107 (3) |
| 5 (Comp.) | ACR (80) | A4 (5) | — |
| 6 (Inv.) | AR-4 (80) | — | — |
| 7 (Inv.) | AR-4 (80) | A4 (5) | — |
| 8 (Inv) | ACR/AR-4 | A4 (5) | BR 22 (3) |
| | (60/20) | | |
| 9 (Inv) | ACR/AR-2 | A4 (5) | BR 22 (3) |
| | (60/20) | | |
| 10 (Inv) | ACR/AR-1 | A4 (5) | BR 22 (3) |
| | (60/20) | | |
| 11 (Inv) | ACR (80) | A4 (5) | BR 22 (3) |
| 12 (Inv) | ACR (80) | A4 (5) | BR 22 (3) |
| 13 (Inv) | ACR (80) | A4 (5) | BR 22 (3) |
| 14 (Inv) | AR-1 (80) | A4 (5) | BR22 (3) |
| 15 (Inv) | AR-1 (80) | A4 (5) | TAZ 107 (3) |
| 16 (Inv) | AR-4 (80) | A4 (5) | TAZ 107 (3) |

A4: Synthesis Example A4 of acid-decomposable compound of formula (6)
ACR: Acryl resin 1
TAZ 107: triazine compound (Midori Kagaku Co.)

TABLE 3

Upper Layer

| | | Acid- | |
|---|---|---|---|
| | | decomposable | Fluoroacryl |
| Sample | | Compound | Resin |
| No. | Resin (%) | (part) | (part) |
| 1 (Comp.) | CNR (80) | — | — |
| 2 (Comp.) | CNR (80) | — | — |
| 3 (Comp.) | CNR (80) | S1 (4) | — |
| 4 (Comp.) | CNR (70) | S1 (4) | AP-1 (10) |
| 5 (Comp.) | CNR (70) | S1 (4) | AP-1 (10) |
| 6 (Inv.) | CNR (80) | — | — |
| 7 (Inv.) | CNR (80) | — | — |
| 8 (Inv.) | CNR (80) | — | — |
| 9 (Inv.) | CNR (80) | — | — |
| 10 (Inv.) | CNR (80) | — | — |
| 11 (Inv.) | N-3 (80) | — | — |
| 12 (Inv.) | N-3 (80) | S1 (4) | AP-1 (10) |
| 13 (Inv.) | CNR/N-3 | S1 (4) | AP-1 (10) |
| | (60/20) | | |
| 14 (Inv.) | N-3 (80) | S1 (4) | AP-1 (10) |
| 15 (Inv.) | N-3 (80) | S1 (4) | AP-1 (10) |
| 16 (Inv.) | N-1 (80) | S1 (4) | AP-1 (10) |

AP-1: Fluoroacryl resin (AP-1 described in JP-A No. 2006-10
CNR: Cresol novolak resin (m/p = 6/4, M. W. = 4000)
S1: Acid-generating agent:

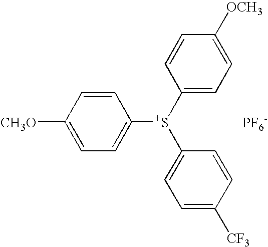

TABLE 4

| | | Development | Abrasion |
|---|---|---|---|
| | Sensitivity | Latitude | Resistance |
| Sample No. | (mJ/cm²) | (sec) | (g) |
| 1 (Comp.) | 160 | 20 | 1 |
| 2 (Comp.) | 140 | 30 | 1 |
| 3 (Comp.) | 155 | 20 | 1 |
| 4 (Comp.) | 140 | 25 | 2 |
| 5 (Comp.) | 150 | 25 | 2 |
| 6 (Inv.) | 90 | 60 | 3 |
| 7 (Inv.) | 80 | 70 | 3 |
| 8 (Inv.) | 110 | 45 | 3 |
| 9 (Inv.) | 100 | 50 | 3 |
| 10 (Inv.) | 100 | 45 | 3 |
| 11 (Inv.) | 80 | 80 | 3 |
| 12 (Inv.) | 90 | 70 | 4 |
| 13 (Inv.) | 100 | 60 | 3 |
| 14 (Inv.) | 70 | 90 | 5 |
| 15 (Inv.) | 60 | 100 | 5 |
| 16 (Inv.) | 70 | 110 | 5 |

What is claimed is:

1. A lithographic printing plate material comprising on a support a light-sensitive layer comprising a binder, wherein the light sensitive layer comprises a resin having a cyclic ureido residue derived from a cyclic ureido compound represented by formulas (1), (2), (3), (4), or (5): 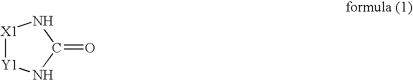
wherein X1 and Y1 are each independently —O—, —N(R1)- or —C(R1)₂- in which R1 is a hydrogen atom, a halogen atom or a substituent, or X1 and Y1 are —C(═O)—; 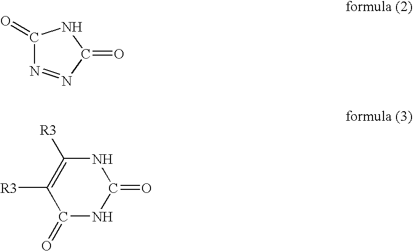
wherein R3 is the same as defined in R1; 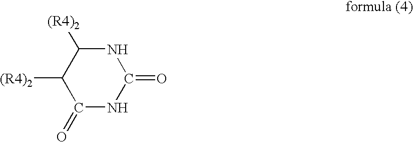
wherein R4 is the same as defined in R1;

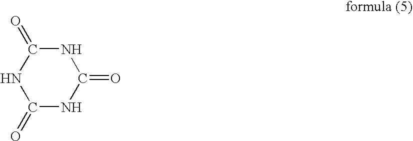

2. The printing plate material of claim 1, wherein the light sensitive layer comprises a resin having a cyclic ureido residue derived from a cyclic ureido compound represented by formulas (1), (3) or (5)

3. The printing plate material of claim 1, wherein the cyclic ureido compound has at least two amido bonds.

4. The printing plate material of claim 1, wherein the cyclic ureido compound is a 6-membered cyclic ureido compound.

5. The printing plate material of claim 1, wherein the cyclic ureido compound is selected from the group consisting of urazole, parabanic acid, uracil, thymine, orotic acid and isocyanuric acid.

6. The printing plate material of claim 4, wherein the cyclic ureido compound is uracil, thymine or isocyanuric acid.

7. The printing plate material of claim 6, wherein the cyclic ureido compound is isocyanuric acid.

8. The printing plate material of claim 1, wherein the resin comprises a backbone having a side chain and the side chain contains the cyclic ureido residue.

9. The printing plate material of claim 1, wherein the resin is a resin soluble in an aqueous alkaline solution.

10. The printing plate material of claim 1, wherein the resin is at least one selected from the group consisting of an acryl resin, an acetal resin and a phenol resin.

11. The printing plate material of claim 10, wherein the phenol resin is a novolak resin.

12. The printing plate material of claim 1, wherein the light-sensitive layer comprises an acid-decomposable compound represented by formula (6): 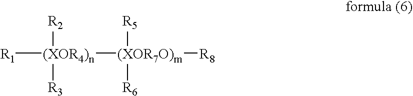
wherein R₁ is a hydrogen atom, an alkyl group, an aryl group, an alkoxy group an aryloxy group or a halogen atom; R₂ and R₅ are each a hydrogen atom, an alkyl group or an aryl group; R₃ and R₆ are each an alkyl group or an aryl group, provided that R₂ and R₃ or R₅ and R₆ may combine with each other to form a ring which may be substituted; R₄ is an ethyleneoxy group or a propyleneoxy group; R₇ is an alkylene group; R₈ is a hydrogen atom or —XR₂R₃R₁ or —XR₅R₆R₁; X is a carbon atom or a silicon atom; n is an integer of 1 or more and m is an integer of 0, 1 or more.

13. The printing plate material of claim 12, wherein the acid-decomposable compound is acetals.

14. The printing plate material of claim 1, wherein the light-sensitive layer comprises at least two layers comprising a lower layer having thereon an upper layer and at least one of the two layers comprises the resin.

15. The printing plate material of claim 14, wherein the lower layer comprises at least one of a compound represented by formula (7) or (8) and an acryl resin containing a fluoroalkyl group:
R¹—C(X)₂—C(═O)—R² formula (7)
wherein R¹ is a hydrogen atom, a bromine atom, a chlorine atom, an alkyl group, an aryl group, an acyl group, an alkyl sulfonyl group, an arylsulfonyl group, an iminosulfonyl group or a cyano group; R² is a hydrogen atom or a univalent organic substituent, provided that R¹ and R² may combine with each other to form a ring; X is a bromine atom or a chlorine atom; 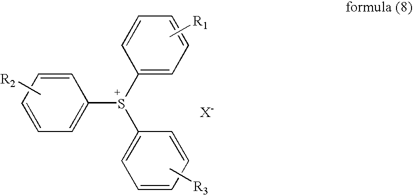
wherein R₁, R₂ and R₃ are each a hydrogen atom or a substituent, provided that all of R₁, R₂ and R₃ are not hydrogen atoms and X⁻ is an anion.

16. The printing plate material of claim 14, wherein the lower layer comprises an acryl resin having a sulfonamido group or a phenolic hydroxyl group.

17. The printing plate material of claim 14, wherein the lower layer comprises at least one of a compound represented by formula (6) or a compound represented by formula (7): 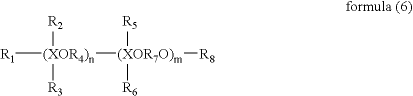
wherein R₁ is a hydrogen atom, an alkyl group, an aryl group, an alkoxy group an aryloxy group or a halogen atom; R₂ and R₅ are each a hydrogen atom, an alkyl group or an aryl group; R₃ and R₆ are each an alkyl group or an aryl group, provided that R₂ and R₃ or R₅ and R₆ may combine with each other to form a ring which may be substituted; R₄ is an ethyleneoxy group or a propyleneoxy group; R₇ is an alkylene group; R₈ is a hydrogen atom or —XR₂R₃R₁ or —XR₅R₆R₁; X is a carbon atom or a silicon atom; n is an integer of 1 or more and m is an integer of 0, 1 or more;
R¹—C(X)₂—C(═O)—R² formula (7)
wherein R¹ is a hydrogen atom, a bromine atom, a chlorine atom, an alkyl group, an aryl group, an acyl group, an alkyl sulfonyl group, an arylsulfonyl group, an iminosulfonyl group or a cyano group; R² is a hydrogen atom or a univalent organic substituent, provided that R¹ and R² may combine with each other to form a ring; X is a bromine atom or a chlorine atom.

18. The printing plate material of claim 1, wherein the light-sensitive layer comprises an infrared-absorbing compound and the printing plate material is a lithographic positive-working printing plate material.
